(19) United States
(12) Patent Application Publication
(10) Pub. No.: US 2025/0035468 A1
(43) Pub. Date: Jan. 30, 2025

(54) POSITION DETECTION DEVICE, KEY SWITCH, KEYBOARD, MOUSE, AND GAME CONTROLLER

(71) Applicant: TDK Corporation, Tokyo (JP)

(72) Inventors: Yongfu CAI, Tokyo (JP); Tsuyoshi UMEHARA, Tokyo (JP); Takafumi KOBAYASHI, Tokyo (JP)

(73) Assignee: TDK Corporation, Tokyo (JP)

(21) Appl. No.: 18/917,328

(22) Filed: Oct. 16, 2024

Related U.S. Application Data
(63) Continuation-in-part of application No. 18/212,818, filed on Jun. 22, 2023.
Application No. 18/212,818 is a continuation of application No. 17/114,664, filed on Dec. 8, 2020, now Pat. No. 11,719,556.

(30) Foreign Application Priority Data
Feb. 13, 2020 (JP) 2020-022389

(51) Int. Cl. G01D 5/16; G01D 5/14; G03B 30/00; H02K 11/215; H04N 23/54

(52) U.S. Cl. CPC G01D 5/16; G01D 5/147; G03B 30/00; H02K 11/215; H04N 23/54

(57) ABSTRACT

A position detection device includes a magnetic field generator and a magnetic sensor. The magnetic field generator is configured so that a mode of variation in a target magnetic field relative to variation in a position of a key cap varies nonlinearly relative to the variation in the position of the key cap. The magnetic sensor is configured so that a mode of variation in a detection signal relative to the variation in the target magnetic field varies nonlinearly relative to the variation in the target magnetic field.

### CROSS REFERENCE TO RELATED APPLICATIONS

This application is a continuation-in-part application of U.S. patent application Ser. No. 18/212,818, filed on Jun. 22, 2023, which is a continuation of U.S. patent application Ser. No. 17/114,664, filed on Dec. 8, 2020, which claims priority to Japanese Patent Application No. 2020-0022389, filed on Feb. 13, 2020, the entire contents of each of which are incorporated herein by its reference.

### BACKGROUND

The technology relates to a position detection device using a magnetic sensor, a key switch using the position detection device, and a keyboard, a mouse, and a game controller using the position detection device.

Recently, position detection devices using magnetic sensors have been used for a variety of applications. The position detection devices using magnetic sensors will hereinafter be referred to as magnetic position detection devices. For example, the magnetic position detection devices are used for detecting a position of a lens in a camera module having an autofocus mechanism incorporated in a smartphone.

US 2016/0231528 A1 describes a technology of detecting a composite vector with a position sensor in an autofocus mechanism in which a lens is movably provided to a substrate. The composite vector is generated by interaction between a first magnetic field having a constant strength in a first direction and a second magnetic field in a second direction generated by a magnet that moves with the lens. The second direction is orthogonal to the first direction. According to the technology, the magnitude of the second magnetic field varies depending on the position of the lens, and as a result, the angle that the composite vector forms with the second direction (hereinafter referred to as a composite vector angle) also varies. According to the technology, the position of the lens can be detected by detecting the composite vector angle.

US 2019/0128699 A1 describes a position detection device using a magnetoresistive element of a spin-valve structure. The position detection device includes a first magnetic field generation unit, a second magnetic field generation unit whose position relative to the first magnetic field generation unit is variable, and a magnetic sensor that generates a detection signal corresponding to the direction of a magnetic field to be detected. The magnetic field to be detected is a composite magnetic field of a magnetic field generated by the first magnetic field generation unit and a magnetic field generated by the second magnetic field generation unit. In this position detection device, the direction and strength of the magnetic field to be detected vary when the position of the second magnetic field generation unit relative to the first magnetic field generation unit varies. According to such a position detection device, the position of the second magnetic field generation unit relative to the first magnetic field generation unit can be detected by measuring the detection signal.

As described in US 2016/0231528 A1 and US 2019/0128699 A1, in a magnetic position detection device, the direction of the magnetic field to be detected by the magnetic sensor (hereinafter, referred to as a target magnetic field) varies when the position of a detection target (hereinafter, referred to as an object) of the position detection device varies. When the direction of the target magnetic field varies, the detection signal varies. The detection signal desirably varies linearly relative to variation in the position of the object. That the detection signal “varies linearly” means that the detection signal varies linearly or substantially linearly relative to variation in the position of the object in a characteristic diagram expressing the relationship between the position of the object and the detection signal. That the detection signal “varies nonlinearly” means that the detection signal does not vary linearly or substantially linearly, like varying in a curved manner, relative to variation in the position of the object in the foregoing characteristic diagram.

To make the detection signal vary linearly relative to variation in the position of the object, it is desirable for the direction of the target magnetic field to vary linearly relative to the variation in the position of the object and for the detection signal to vary linearly relative to variation in the direction of the target magnetic field. FIG. 10 of US 2019/0128699 A1 discloses that the angle that the direction of the target magnetic field forms with a reference direction varies linearly relative to variation in the position of the second magnetic field generation unit relative to the first magnetic field generation unit.

In fact, because of mechanical limitations, a mode of variation in the direction of the target magnetic field relative to variation in the position of the object is sometimes forced to be such that the direction of the target magnetic field varies nonlinearly. FIG. 8B of US 2016/0231528 A1 discloses that the composite vector angle varies in a curved manner, i.e., nonlinearly relative to variation in the position of the magnet that moves with the lens. In such a case, processing for correcting the detection signal is needed since the detection signal varies nonlinearly relative to the variation in the position of the object.

### SUMMARY

One example embodiment of the technology is directed to providing a position detection device for detecting a position of an object whose position is variable. The position detection device according to one example embodiment of the technology includes a magnetic field generator configured to generate a target magnetic field and vary the target magnetic field when the position of the object varies, and a magnetic sensor that detects the target magnetic field and generates a detection signal corresponding to variation in the target magnetic field. The magnetic field generator is configured so that a mode of the variation in the target magnetic field relative to variation in the position of the object varies nonlinearly relative to the variation in the position of the object. The magnetic sensor is configured so that a mode of variation in the detection signal relative to the variation in the target magnetic field varies nonlinearly relative to the variation in the target magnetic field.

A key switch according to one example embodiment of the technology includes a key cap, a holding member configured to hold the key cap while allowing the key cap to move linearly, and a position detection device for detecting a position of the key cap. The position detection device includes a magnetic field generator configured to generate a target magnetic field and vary the target magnetic field when the position of the key cap varies, and a magnetic sensor that detects the target magnetic field and generates a detection signal corresponding to variation in the target magnetic field. The magnetic field generator is configured so that a mode of the variation in the target magnetic field relative to variation in the position of the key cap varies nonlinearly relative to the variation in the position of the key cap. The magnetic sensor is configured so that a mode of variation in the detection signal relative to the variation in the target magnetic field varies nonlinearly relative to the variation in the target magnetic field.

A keyboard according to one example embodiment of the technology includes a plurality of key switches, a switch plate to which the plurality of key switches are fixed, and a substrate. Each of the plurality of key switches includes a key cap, a holding member configured to hold the key cap while allowing the key cap to move linearly, and a position detection device for detecting a position of the key cap. The position detection device includes a magnetic field generator configured to generate a target magnetic field and vary the target magnetic field when the position of the key cap varies, and a magnetic sensor that detects the target magnetic field and generates a detection signal corresponding to variation in the target magnetic field. The magnetic field generator is configured so that a mode of the variation in the target magnetic field relative to variation in the position of the key cap varies nonlinearly relative to the variation in the position of the key cap. The magnetic sensor is configured so that a mode of variation in the detection signal relative to the variation in the target magnetic field varies nonlinearly relative to the variation in the target magnetic field.

A mouse according to one example embodiment of the technology includes a button configured to allow at least one of clicking or depressing, a position detection device configured to detect at least one of the clicking or the depressing of the button, and a case. The position detection device includes a magnetic field generator configured to generate a target magnetic field and vary the target magnetic field when a position of the button varies, and a magnetic sensor that detects the target magnetic field and generates a detection signal corresponding to variation in the target magnetic field. The magnetic field generator is configured so that a mode of the variation in the target magnetic field relative to variation in the position of the button varies nonlinearly relative to the variation in the position of the button. The magnetic sensor is configured so that a mode of variation in the detection signal relative to the variation in the target magnetic field varies nonlinearly relative to the variation in the target magnetic field.

A game controller according to one example embodiment of the technology includes a stick button configured to allow at least one of a directional operation or depressing, a position detection device, a case, and a substrate provided in the case. The stick button includes a stick device provided in the case. The stick device includes a lever, and a housing that accommodates a base of the lever and is fixed to the substrate. The position detection device includes a magnetic field generator configured to generate a target magnetic field and vary the target magnetic field when a position of the lever varies, and a magnetic sensor that detects the target magnetic field and generates a detection signal corresponding to variation in the target magnetic field. The magnetic field generator is configured so that a mode of the variation in the target magnetic field relative to variation in the position of the lever varies nonlinearly relative to the variation in the position of the lever. The magnetic sensor is configured so that a mode of variation in the detection signal relative to the variation in the target magnetic field varies nonlinearly relative to the variation in the target magnetic field.

Other and further objects, features, and advantages of the technology will appear more fully from the following description.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a perspective view showing a camera module according to a first example embodiment of the technology.

FIG. 2 is an explanatory diagram schematically showing an inside of the camera module according to the first example embodiment of the technology.

FIG. 3 is a perspective view showing a position detection device and a driving device according to the first example embodiment of the technology.

FIG. 4 is a perspective view showing a plurality of coils of the driving device in FIG. 1.

FIG. 5 is a side view showing principal parts of the driving device in FIG. 1.

FIG. 6 is a perspective view showing principal parts of the position detection device according to the first example embodiment of the technology.

FIG. 7 is a circuit diagram showing a configuration of a magnetic sensor in the first example embodiment of the technology.

FIG. 8 is a perspective view showing a part of a resistor section in FIG. 7.

FIG. 9 is a characteristic diagram showing a relationship between a relative position and first and second magnetic field components in the first example embodiment of the technology.

FIG. 10 is a characteristic diagram showing a relationship between the relative position and a target angle in the first example embodiment of the technology.

FIG. 11 is a characteristic diagram showing a relationship between a relative angle and a detection signal in the first example embodiment of the technology.

FIG. 12 is a schematic diagram showing a relationship between the target angle and the detection signal in the first example embodiment of the technology.

FIG. 13 is an explanatory diagram showing first and second magnetization directions (directions of first and second magnetizations) in a position detection device of a first comparative example.

FIG. 14 is an explanatory diagram showing first and second magnetization directions in a position detection device of a first practical example.

FIG. 15 is a characteristic diagram showing a relationship between a relative position and a relative angle in each of the position detection device of the first comparative example and the position detection device of the first practical example.

FIG. 16 is a characteristic diagram showing a relationship between the relative position and a detection signal, and between the relative position and a third linearity parameter in the position detection device of the first comparative example.

FIG. 17 is a characteristic diagram showing a relationship between the relative position and a detection signal, and between the relative position and a third linearity parameter in the position detection device of the first practical example.

FIG. 18 is a circuit diagram showing a configuration of a magnetic sensor in a position detection device of a second comparative example.

FIG. 19 is a characteristic diagram showing a relationship between a relative position and a detection signal in the position detection device of the second comparative example.

FIG. 20 is a plan view showing a rotary actuator according to a second example embodiment of the technology.

FIG. 21 is a characteristic diagram showing a relationship between a rotational position and a target angle in the second example embodiment of the technology.

FIG. 22 is a characteristic diagram showing a relationship between a relative position and a detection signal in a position detection device of a third comparative example.

FIG. 23 is a characteristic diagram showing a relationship between a relative position and a detection signal in a position detection device of a second practical example.

FIG. 24 is a characteristic diagram showing a relationship between a rotational position and a third linearity parameter in each of the position detection device of the third comparative example and the position detection device of the second practical example.

FIG. 25 is a plan view showing a keyboard in a third example embodiment.

FIG. 26 is a side view showing a key switch in the third example embodiment.

FIG. 27 is a perspective view showing a magnetoresistive element and a bias magnet of a first example in the third example embodiment.

FIG. 28 is a perspective view showing a magnetoresistive element of a second example in the third example embodiment.

FIG. 29 is a perspective view showing a position detection device according to a fourth example embodiment.

FIG. 30 is a plan view showing a mouse in a fifth example embodiment.

FIG. 31 is a side view showing a position detection device according to the fifth example embodiment.

FIG. 32 is an explanatory diagram showing a game controller in a sixth example embodiment.

FIG. 33 is a perspective view showing a stick device in the sixth example embodiment.

FIG. 34 is a perspective view showing a lever in a seventh example embodiment.

FIG. 35 is a perspective view showing a stick device in the seventh example embodiment.

### DETAILED DESCRIPTION

An object of the technology is to provide a position detection device using a magnetic sensor, in which the position detection device can cause a detection signal to vary linearly relative to variation in a position of an object even if a direction of a target magnetic field varies nonlinearly relative to the variation in the position of the object, a key switch using the position detection device, and a keyboard, a mouse, and a game controller using the position detection device.

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions. Note that the description is given in the following order.

### First Example Embodiment

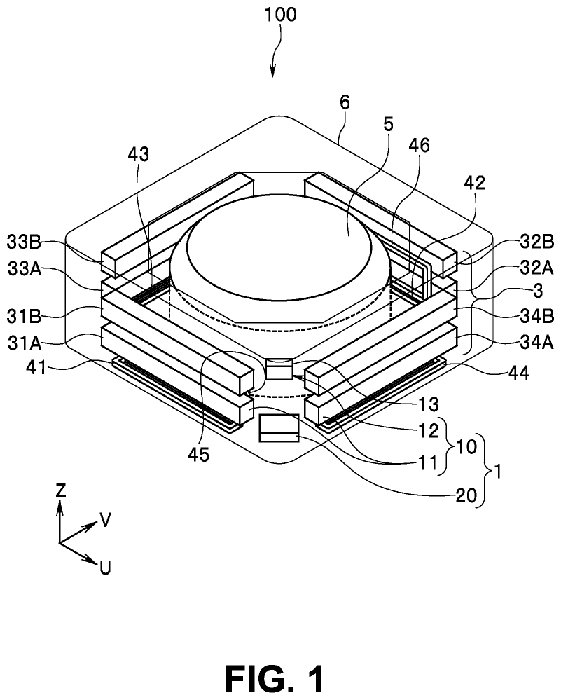

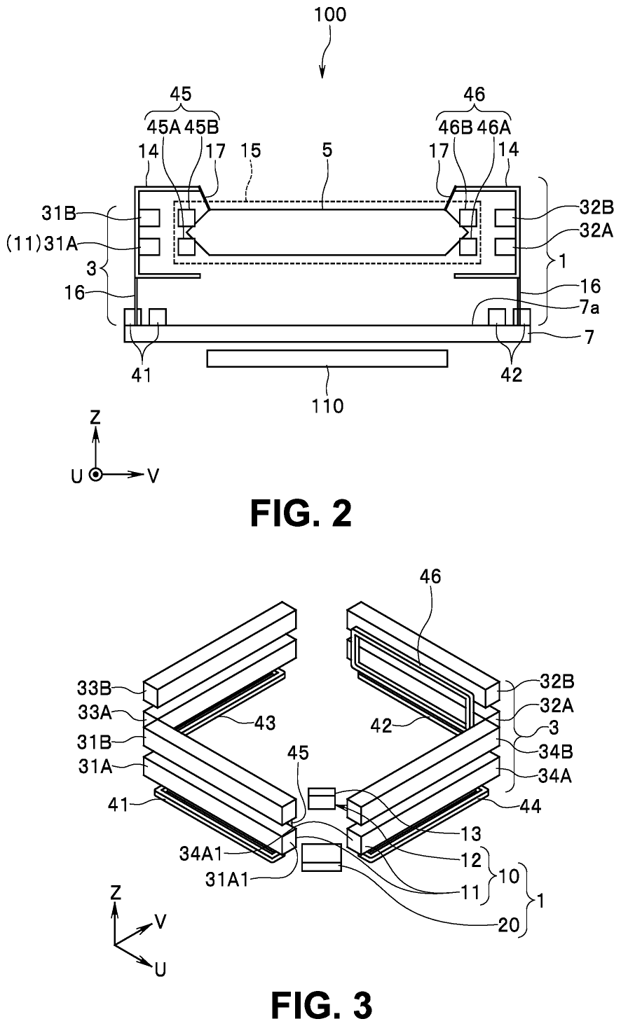

First, reference is made to FIG. 1 and FIG. 2 to describe a configuration of a camera module according to a first example embodiment of the technology. FIG. 1 is a perspective view showing a camera module 100. FIG. 2 is an explanatory diagram schematically showing an inside of the camera module 100. Note that for ease of understanding, in FIG. 2, parts of the camera module 100 are drawn on a different scale and in a different layout than those in FIG. 1. The camera module 100 according to the example embodiment constitutes, for example, a part of a camera for a smartphone having an optical image stabilization mechanism and an autofocus mechanism, and is used in combination with an image sensor 110 that uses CMOS or other similar techniques.

The camera module 100 according to the example embodiment includes a position detection device 1 according to the example embodiment, a driving device 3, a lens 5, a case 6, and a substrate 7. The position detection device 1 according to the example embodiment is a magnetic position detection device, and is used to detect the position of the lens 5 during automatic focusing. The driving device 3 is to move the lens 5. The case 6 is to protect the position detection device 1 and the driving device 3. The substrate 7 has a top surface 7a. FIG. 1 omits the illustration of the substrate 7, and FIG. 2 omits the illustration of the case 6.

Here, U, V, and Z directions are defined as shown in FIGS. 1 and 2. The U, V, and Z directions are orthogonal to one another. In the example embodiment, the Z direction is a direction perpendicular to the top surface 7a of the substrate 7 (in FIG. 2, the Z direction is an upward direction). The U and V directions are both parallel to the top surface 7a of the substrate 7. The opposite directions to the U, V, and Z directions are referred to as −U, −V, and −Z directions, respectively. As used herein, the term “above” refers to positions located forward of a reference position in the Z direction, and “below” refers to positions located on a side of the reference position opposite from “above”.

The lens 5 is disposed above the top surface 7a of the substrate 7 in such an orientation that a direction of an optical axis of the lens 5 is parallel to the Z direction. The substrate 7 has an opening (not illustrated) for passing light that has passed through the lens 5. As shown in FIG. 2, the camera module 100 is in alignment with the image sensor 110 so that light that has passed through the lens 5 and the not-illustrated opening enters the image sensor 110.

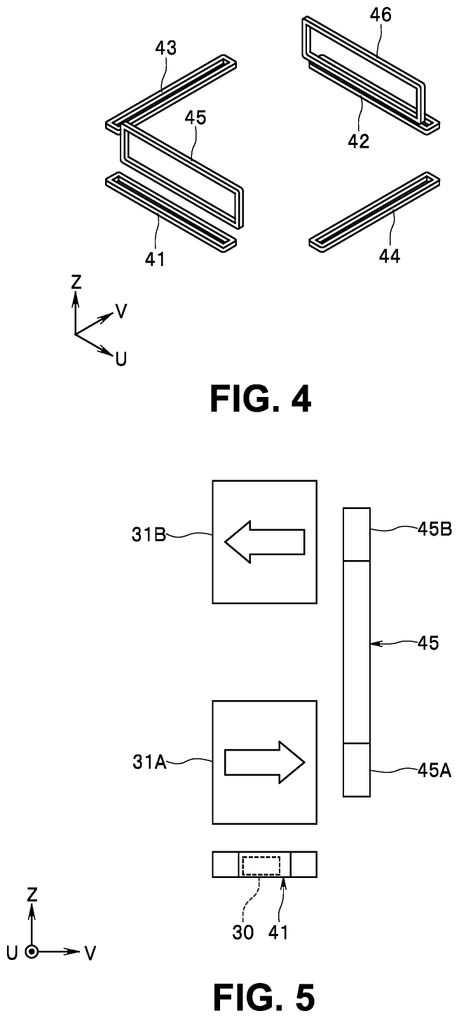

The position detection device 1 and the driving device 3 according to the example embodiment will now be described in detail with reference to FIG. 2 to FIG. 5. FIG. 3 is a perspective view showing the position detection device 1 and the driving device 3. FIG. 4 is a perspective view showing a plurality of coils of the driving device 3. FIG. 5 is a side view showing principal parts of the driving device 3.

The position detection device 1 includes a first holding member 14, a second holding member 15, a plurality of first wires 16, and a plurality of second wires 17. The second holding member 15 is to hold the lens 5. Although not illustrated, the second holding member 15 has, for example, a cylindrical shape so that the lens 5 is mounted inside thereof.

The second holding member 15 is provided such that its position is variable in one direction, specifically, in the direction of the optical axis of the lens 5, i.e., a direction parallel to the Z direction, relative to the first holding member 14. In the example embodiment, the first holding member 14 is box-shaped so that the lens 5 and the second holding member 15 can be accommodated therein. The plurality of second wires 17 connect the first and second holding members 14 and 15, and support the second holding member 15 such that the second holding member 15 is movable in a direction parallel to the Z direction relative to the first holding member 14.

The first holding member 14 is provided above the top surface 7a of the substrate 7 such that its position is variable relative to the substrate 7 in a direction parallel to the U direction and in a direction parallel to the V direction. The plurality of first wires 16 connect the substrate 7 and the first holding member 14, and support the first holding member 14 such that the first holding member 14 is movable relative to the substrate 7 in a direction parallel to the U direction and in a direction parallel to the V direction. When the position of the first holding member 14 relative to the substrate 7 varies, the position of the second holding member 15 relative to the substrate 7 also varies.

The driving device 3 includes magnets 31A, 31B, 32A, 32B, 33A, 33B, 34A, and 34B, and coils 41, 42, 43, 44, 45, and 46. The magnet 31A is located forward of the lens 5 in the −V direction. The magnet 32A is located forward of the lens 5 in the V direction. The magnet 33A is located forward of the lens 5 in the −U direction. The magnet 34A is located forward of the lens 5 in the U direction. The magnets 31B, 32B, 33B, and 34B are located above the magnets 31A, 32A, 33A, and 34A, respectively. The magnets 31A, 31B, 32A, 32B, 33A, 33B, 34A, and 34B are fixed to the first holding member 14.

As shown in FIG. 3, the magnets 31A, 31B, 32A, and 32B are each in the shape of a rectangular solid that is long in the U direction. The magnets 33A, 33B, 34A, and 34B are each in the shape of a rectangular solid that is long in the V direction. The magnets 31A and 32B are magnetized in the V direction. The magnets 31B and 32A are magnetized in the −V direction. The magnets 33A and 34B are magnetized in the U direction. The magnets 33B and 34A are magnetized in the −U direction. In FIG. 5, the arrows drawn inside the magnets 31A and 31B indicate the magnetization directions of the magnets 31A and 31B.

The coil 41 is located between the magnet 31A and the substrate 7. The coil 42 is located between the magnet 32A and the substrate 7. The coil 43 is located between the magnet 33A and the substrate 7. The coil 44 is located between the magnet 34A and the substrate 7. The coil 45 is located between the lens 5 and the magnets 31A and 31B. The coil 46 is located between the lens 5 and the magnets 32A and 32B. The coils 41, 42, 43, and 44 are fixed to the substrate 7. The coils 45 and 46 are fixed to the second holding member 15.

The coil 41 is subjected mainly to a magnetic field generated by the magnet 31A. The coil 42 is subjected mainly to a magnetic field generated by the magnet 32A. The coil 43 is subjected mainly to a magnetic field generated by the magnet 33A. The coil 44 is subjected mainly to a magnetic field generated by the magnet 34A.

As shown in FIGS. 2, 4, and 5, the coil 45 includes a first conductor portion 45A extending along the magnet 31A in the U direction, a second conductor portion 45B extending along the magnet 31B in the U direction, and two third conductor portions connecting the first and second conductor portions 45A and 45B. As shown in FIGS. 2 and 4, the coil 46 includes a first conductor portion 46A extending along the magnet 32A in the U direction, a second conductor portion 46B extending along the magnet 32B in the U direction, and two third conductor portions connecting the first and second conductor portions 46A and 46B.

The first conductor portion 45A of the coil 45 is subjected mainly to a component in the V direction of the magnetic field generated by the magnet 31A. The second conductor portion 45B of the coil 45 is subjected mainly to a component in the −V direction of a magnetic field generated by the magnet 31B. The first conductor portion 46A of the coil 46 is subjected mainly to a component in the −V direction of the magnetic field generated by the magnet 32A. The second conductor portion 46B of the coil 46 is subjected mainly to a component in the V direction of a magnetic field generated by the magnet 32B.

The position detection device 1 further includes a magnetic field generator 10 and a magnetic sensor 20. The magnetic field generator 10 generates a target magnetic field MF that is a magnetic field for the magnetic sensor 20 to detect (magnetic field to be detected). In the example embodiment, the magnetic field generator 10 includes a first magnetic field generation unit 11 that generates a first magnetic field and a second magnetic field generation unit 12 that generates a second magnetic field. The first magnetic field generation unit 11 includes two magnets disposed at different positions. In the example embodiment, specifically, the first magnetic field generation unit 11 includes the magnets 31A and 34A as the aforementioned two magnets. The first magnetic field is a composite of the magnetic fields generated by the magnets 31A and 34A. As mentioned above, the magnets 31A and 34A are fixed to the first holding member 14. The first magnetic field generation unit 11 is thus held by the first holding member 14.

As shown in FIG. 3, the magnet 31A has an end face 31A1 located at the end of the magnet 31A in the U direction. The magnet 34A has an end face 34A1 located at the end of the magnet 34A in the −V direction.

The second magnetic field generation unit 12 is provided such that its position relative to the first magnetic field generation unit 11 is variable. In the example embodiment, the second magnetic field generation unit 12 includes a magnet 13. The second magnetic field is a magnetic field generated by the magnet 13. The magnet 13 is in the shape of a rectangular solid. The magnet 13 is fixed to the second holding member 15 in a space near the end face 31A1 of the magnet 31A and the end face 34A1 of the magnet 34A. The second magnetic field generation unit 12 is thus held by the second holding member 15. When the position of the second holding member 15 relative to the first holding member 14 varies in a direction parallel to the Z direction, the position of the second magnetic field generation unit 12 relative to the first magnetic field generation unit 11 also varies in the direction parallel to the Z direction.

The magnetic sensor 20 includes at least one magnetoresistive element. Hereinafter, the magnetoresistive element will be referred to as an MR element. The magnetic sensor 20 detects a target magnetic field MF at a detection position in a reference plane, and generates a detection signal corresponding to the direction of the target magnetic field MF. The magnetic sensor 20 is fixed to the substrate 7 near the end face 31A1 of the magnet 31A and the end face 34A1 of the magnet 34A. The distance between the magnet 31A and the magnetic sensor 20 is equal to the distance between the magnet 34A and the magnetic sensor 20. The magnet 13 is located above the magnetic sensor 20.

The detection position is a position at which the magnetic sensor 20 detects the first magnetic field and the second magnetic field. In the example embodiment, the reference plane is a plane that contains the detection position and is perpendicular to the Z direction. When the position of the second magnetic field generation unit 12 relative to the first magnetic field generation unit 11 varies, the distance between the detection position and the second magnetic field generation unit 12 varies.

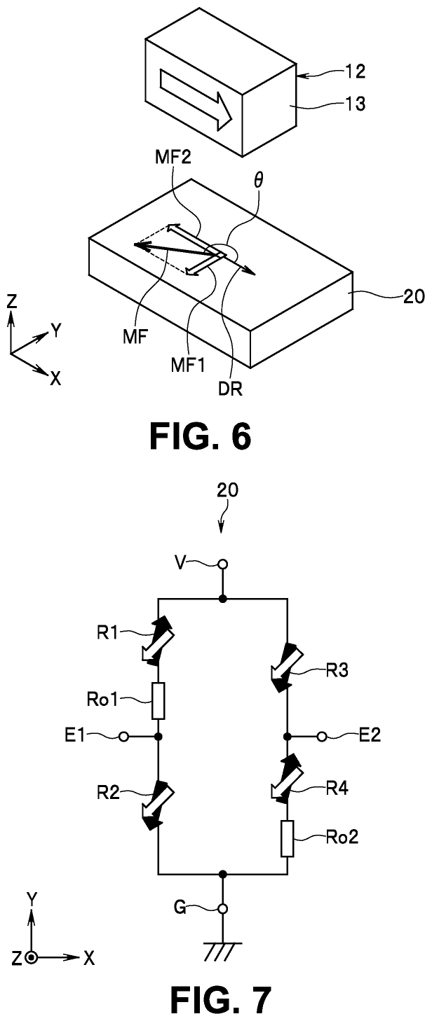

A component of the first magnetic field at the detection position, the component being parallel to the reference plane, will be referred to as a first magnetic field component MF1. A component of the second magnetic field at the detection position, the component being parallel to the reference plane, will be referred to as a second magnetic field component MF2. The target magnetic field MF is a composite magnetic field of the first magnetic field component MF1 and the second magnetic field component MF2. The first and second magnetic field components MF1 and MF2 and the target magnetic field MF are shown in FIG. 6 to be described later.

Positional relationships among the first magnetic field generation unit 11, the second magnetic field generation unit 12, and the magnetic sensor 20, and a configuration of the magnetic sensor 20 will be described in more detail later.

The driving device 3 further includes a magnetic sensor 30 disposed on the inner side of one of the coils 41 and 42 and fixed to the substrate 7, and a magnetic sensor 30 disposed on the inner side of one of the coils 43 and 44 and fixed to the substrate 7. Assume here that the two magnetic sensors 30 are disposed on the inner sides of the coils 41 and 44, respectively. As will be described later, the two magnetic sensors 30 are used to vary the position of the lens 5 to reduce the effect of hand-induced camera shake.

The magnetic sensor 30 disposed on the inner side of the coil 41 detects the magnetic field generated by the magnet 31A and generates a signal corresponding to the position of the magnet 31A. The magnetic sensor 30 disposed on the inner side of the coil 44 detects the magnetic field generated by the magnet 34A and generates a signal corresponding to the position of the magnet 34A. For example, the magnetic sensors 30 are constructed of elements for detecting magnetic fields, such as Hall elements.

The positional relationships among the first magnetic field generation unit 11, the second magnetic field generation unit 12, and the magnetic sensor 20 will now be described in detail with reference to FIGS. 3 and 6. FIG. 6 is a perspective view showing principal parts of the position detection device 1. Here, X and Y directions are defined as shown in FIG. 6. Both the X and Y directions are parallel to the top surface 7a (see FIG. 2) of the substrate 7. The X direction is a direction rotated by 45° from the U direction toward the V direction. The Y direction is a direction rotated by 45° from the V direction toward the −U direction. The opposite directions to the X and Y directions will be referred to as −X and −Y directions, respectively.

In FIG. 6, the arrow denoted by the symbol MF1 indicates the first magnetic field component MF1. In the example embodiment, the first magnetic field generation unit 11 and the magnetic sensor 20 are provided to orient the first magnetic field component MF1 in the −Y direction. The direction of the first magnetic field component MF1 is adjustable by adjusting, for example, the positional relationships of the magnets 31A and 34A relative to the magnetic sensor 20 and the orientations of the magnets 31A and 34A. The magnets 31A and 34A may be placed to be symmetric relative to a YZ plane that contains the detection position.

In FIG. 6, the arrow denoted by the symbol MF2 indicates the second magnetic field component MF2, and the arrow drawn inside the magnet 13 indicates the magnetization direction of the magnet 13. The direction of the second magnetic field component MF2 is different from the direction of the first magnetic field component MF1. The direction of the target magnetic field MF is different from both of the directions of the first and second magnetic field components MF1 and MF2, and is between those directions. The variable range of the direction of the target magnetic field MF is less than 180°. In the example embodiment, specifically, the second magnetic field component MF2 is in the −X direction orthogonal to the direction of the first magnetic field component MF1. In this case, the variable range of the direction of the target magnetic field MF is less than 90°.

An example of the configuration of the magnetic sensor 20 will now be described with reference to FIG. 7. FIG. 7 is a circuit diagram showing the configuration of the magnetic sensor 20. In the example embodiment, the magnetic sensor 20 is configured to generate, as a detection signal corresponding to the direction of the target magnetic field MF, a detection signal corresponding to an angle that the direction of the target magnetic field MF forms with a reference direction. In the example embodiment, the reference direction is the X direction.

As illustrated in FIG. 7, the magnetic sensor 20 includes a power supply port V to which a predetermined voltage is applied, a ground port G that is connected to a ground, a first output port E1, a second output port E2, a first resistor section R1, a second resistor section R2, a third resistor section R3, and a fourth resistor section R4. The first resistor section R1 is provided between the power supply port V and the first output port E1. The second resistor section R2 is provided between the first output port E1 and the ground port G. The third resistor section R3 is provided between the power supply port V and the second output port E2. The fourth resistor section R4 is provided between the second output port E2 and the ground port G.

The first resistor section R1 includes at least one first MR element. The second resistor section R2 includes at least one second MR element. The third resistor section R3 includes at least one third MR element. The fourth resistor section R4 includes at least one fourth MR element.

In the example embodiment, specifically, the first resistor section R1 includes a plurality of first MR elements connected in series, the second resistor section R2 includes a plurality of second MR elements connected in series, the third resistor section R3 includes a plurality of third MR elements connected in series, and the fourth resistor section R4 includes a plurality of fourth MR elements connected in series.

The magnetic sensor 20 further includes a first resistor Ro1 and a second resistor Ro2 each having a predetermined resistance value. The first resistor Ro1 is connected in series to the at least one first MR element so that the first resistor Ro1 is located between the power supply port V and the first output port E1. The second resistor Ro2 is connected in series to the at least one fourth MR element so that the second resistor Ro2 is located between the second output port E2 and the ground port G. In the example illustrated in FIG. 7, the first resistor Ro1 is located between the first resistor section R1 and the first output port E1. The second resistor Ro2 is located between the fourth resistor section R4 and the ground port G.

Each of the plurality of MR elements included in the magnetic sensor 20 is a spin-valve MR element. The spin-valve MR element includes a magnetization pinned layer, a free layer, and a gap layer. The magnetization pinned layer has a first magnetization that is parallel to the reference plane and fixed in direction. The free layer has a second magnetization that is parallel to the reference plane and that can vary in direction according to the direction of the target magnetic field MF. The gap layer is located between the magnetization pinned layer and the free layer. The spin-valve MR element may be a tunneling magnetoresistive (TMR) element or a giant magnetoresistive (GMR) element. In the TMR element, the gap layer is a tunnel barrier layer. In the GMR element, the gap layer is a nonmagnetic conductive layer. The spin-valve MR element varies in resistance value according to the angle that the second magnetization direction of the free layer forms with the first magnetization direction of the magnetization pinned layer, and has a minimum resistance value when the foregoing angle is 0° and a maximum resistance value when the foregoing angle is 180°. In FIG. 7, the filled arrows indicate the magnetization directions of the magnetization pinned layers in the MR elements, and the hollow arrows indicate the magnetization directions of the free layers in the MR elements.

The first magnetization directions of the magnetization pinned layers in the plurality of MR elements included in the first and fourth resistor sections R1 and R4 are in a first direction. The first magnetization directions of the magnetization pinned layers in the plurality of MR elements included in the second and third resistor sections R2 and R3 are in a second direction opposite to the first direction.

In the light of the production accuracy of the MR elements and other factors, the first magnetization directions of the magnetization pinned layers in the plurality of MR elements in the first to fourth resistor sections R1, R2, R3 and R4 may be slightly different from the above-described directions.

The electric potential at the output port E1, the electric potential at the output port E2, and the potential difference between the output ports E1 and E2 vary according to the cosine of the angle that the direction of the target magnetic field MF forms with the first direction. The magnetic sensor 20 outputs a signal corresponding to the potential difference between the output ports E1 and E2 as a detection signal. The detection signal depends on the electric potential at the output port E1, the electric potential at the output port E2, and the potential difference between the output ports E1 and E2. The detection signal varies according to the direction of the target magnetic field MF, and therefore corresponds to the direction of the target magnetic field MF.

The magnetic sensor 20 may further include a not-illustrated difference detector. The not-illustrated difference detector outputs a signal corresponding to the potential difference between the output ports E1 and E2 as the detection signal.

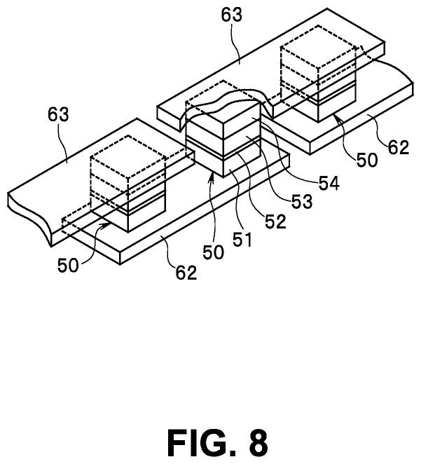

An example of a configuration of the resistor sections R1, R2, R3, and R4 will now be described with reference to FIG. 8. FIG. 8 is a perspective view showing a part of one of the resistor sections R1, R2, R3, and R4. In this example, the resistor section includes a plurality of lower electrodes 62, a plurality of MR elements 50, and a plurality of upper electrodes 63. The plurality of lower electrodes 62 are arranged on a substrate (not illustrated). Each of the lower electrodes 62 has a long slender shape. Every two lower electrodes 62 that are adjacent to each other in the longitudinal direction of the lower electrodes 62 have a gap formed therebetween. As shown in FIG. 8, the MR elements 50 are provided on the top surfaces of the lower electrodes 62, near opposite ends in the longitudinal direction. Each of the MR elements 50 includes a free layer 51, a gap layer 52, a magnetization pinned layer 53, and an antiferromagnetic layer 54 which are stacked in this order from the lower electrode 62 side. The free layer 51 is electrically connected to the lower electrode 62. The antiferromagnetic layer 54 is formed of an antiferromagnetic material. The antiferromagnetic layer 54 is in exchange coupling with the magnetization pinned layer 53 so as to fix the magnetization direction of the magnetization pinned layer 53. The plurality of upper electrodes 63 are arranged over the plurality of MR elements 50. Each of the upper electrodes 63 has a long slender shape, and electrically connects between the respective antiferromagnetic layers 54 of two adjacent MR elements 50 that are arranged on two lower electrodes 62 adjacent in the longitudinal direction of the lower electrodes 62. With such a configuration, in the resistor section shown in FIG. 8, the plurality of MR elements 50 are connected in series by the plurality of lower electrodes 62 and the plurality of upper electrodes 63.

It should be appreciated that the layers 51 to 54 in each MR element 50 may be stacked in the reverse order to that shown in FIG. 8. Each MR element 50 may also be configured without the antiferromagnetic layer 54. Such a configuration may include, for example, a magnetization pinned layer of an artificial antiferromagnetic structure, which includes two ferromagnetic layers and a nonmagnetic metal layer interposed between the two ferromagnetic layers, in place of the antiferromagnetic layer 54 and the magnetization pinned layer 53.

Reference is now made to FIG. 2 to FIG. 5 to describe an operation of the driving device 3. First, an optical image stabilization mechanism and an autofocus mechanism will be briefly described. The driving device 3 constitutes part of the optical image stabilization mechanism and the autofocus mechanism. A control unit (not illustrated) external to the camera module 100 controls the driving device 3, the optical image stabilization mechanism, and the autofocus mechanism.

The optical image stabilization mechanism is configured to detect hand-induced camera shake using, for example, a gyrosensor external to the camera module 100. Upon detection of hand-induced camera shake by the optical image stabilization mechanism, the not-illustrated control unit controls the driving device 3 so as to vary the position of the lens 5 relative to the substrate 7 depending on a mode of the camera shake. This stabilizes the absolute position of the lens 5 to reduce the effect of the camera shake. The position of the lens 5 relative to the substrate 7 is varied in a direction parallel to the U direction or in a direction parallel to the V direction, depending on a mode of the camera shake.

The autofocus mechanism is configured to detect a state in which focus is achieved on a subject, using, for example, an image sensor 110 or an autofocus sensor. Using the driving device 3, the not-illustrated control unit varies the position of the lens 5 relative to the substrate 7 in a direction parallel to the Z direction so as to achieve focus on the subject. This enables automatic focusing on the subject.

Next, a description will be given of the operation of the driving device 3 related to the optical image stabilization mechanism. When currents are passed through the coils 41 and 42 by the not-illustrated control unit, the first holding member 14 with the magnets 31A and 32A fixed thereto moves in a direction parallel to the V direction due to interaction between the magnetic fields generated by the magnets 31A and 32A and the magnetic fields generated by the coils 41 and 42. As a result, the lens 5 also moves in the direction parallel to the V direction. On the other hand, when currents are passed through the coils 43 and 44 by the not-illustrated control unit, the first holding member 14 with the magnets 33A and 34A fixed thereto moves in a direction parallel to the U direction due to interaction between the magnetic fields generated by the magnets 33A and 34A and the magnetic fields generated by the coils 43 and 44. As a result, the lens 5 also moves in the direction parallel to the U direction. The not-illustrated control unit detects the position of the lens 5 by measuring signals corresponding to the positions of the magnets 31A and 34A, which are generated by the two magnetic sensors 30.

Next, the operation of the driving device 3 related to the autofocus mechanism will be described. To move the position of the lens 5 relative to the substrate 7 in the Z direction, the not-illustrated control unit passes a current through the coil 45 such that the current flows through the first conductor portion 45A in the U direction and flows through the second conductor portion 45B in the −U direction, and passes a current through the coil 46 such that the current flows through the first conductor portion 46A in the −U direction and flows through the second conductor portion 46B in the U direction. These currents and the magnetic fields generated by the magnets 31A, 31B, 32A and 32B cause a Lorentz force in the Z direction to be exerted on the first and second conductor portions 45A and 45B of the coil 45 and the first and second conductor portions 46A and 46B of the coil 46. This causes the second holding member 15 with the coils 45 and 46 fixed thereto to move in the Z direction. As a result, the lens 5 also moves in the Z direction.

To move the position of the lens 5 relative to the substrate 7 in the −Z direction, the not-illustrated control unit passes currents through the coils 45 and 46 in directions opposite to those in the case of moving the position of the lens 5 relative to the substrate 7 in the Z direction.

The operation and effects of the position detection device 1 according to the example embodiment will now be described. The position detection device 1 is used to detect the position of an object whose position is variable. In the example embodiment, the object is the lens 5 whose position varies in a linear direction. The position detection device 1 according to the example embodiment is used to detect the position of the lens 5.

The magnetic field generator 10 is configured so that the direction of the target magnetic field MF at the detection position in the reference plane varies when the position of the object, i.e., the lens 5 varies. In the example embodiment, the magnetic field generator 10 includes the first and second magnetic field generation units 11 and 12. When the position of the lens 5 relative to the substrate 7 varies, the position of the second holding member 15 also varies relative to each of the substrate 7 and the first holding member 14. As previously mentioned, the first holding member 14 holds the first magnetic field generation unit 11, and the second holding member 15 holds the second magnetic field generation unit 12. Accordingly, when the position of the lens 5 relative to the substrate 7 varies as mentioned above, the position of the second magnetic field generation unit 12 relative to the first magnetic field generation unit 11 varies. Hereinafter, the position of the second magnetic field generation unit 12 relative to the first magnetic field generation unit 11 will be referred to as a relative position and denoted by the symbol PR. In the example embodiment, the relative position is variable in a direction of the optical axis of the lens 5, that is, in a direction parallel to the Z direction.

When the relative position varies, the position of the second magnetic field generation unit 12 relative to the substrate 7 varies whereas the position of the first magnetic field generation unit 11 relative to the substrate 7 does not vary. Accordingly, when the relative position varies, the strength of the second magnetic field component MF2 varies whereas none of the strength and direction of the first magnetic field component MF1 and the direction of the second magnetic field component MF2 varies. When the strength of the second magnetic field component MF2 varies, the direction and strength of the target magnetic field MF vary, and accordingly, the value of the detection signal to be generated by the magnetic sensor 20 also varies. The value of the detection signal varies depending on the relative position. The not-illustrated control unit detects the relative position by measuring the detection signal. The direction and magnitude of variation in the position of the lens 5 relative to the substrate 7 are the same as those of variation in the relative position. The relative position can thus be said to represent the position of the lens 5, or more specifically, the position of the lens 5 relative to the substrate 7.

In the example embodiment, the distance between the detection position when the second magnetic field generation unit 12 is closest to the detection position and the second magnetic field generation unit 12 will be referred to as a shortest distance. The relative position is expressed by a value obtained by subtracting the shortest distance from the distance between the second magnetic field generation unit 12 located at any position and the detection position. Moreover, the angle that the direction of the target magnetic field MF forms with the reference direction, i.e., the X direction will be referred to as a target angle and denoted by the symbol θ. FIG. 6 illustrates the target angle θ. In FIG. 6, the arrow denoted by the symbol DR indicates the reference direction. The target angle θ indicates the direction of the target magnetic field MF. In the example embodiment, the magnetic sensor 20 generates a detection signal corresponding to the target angle θ.

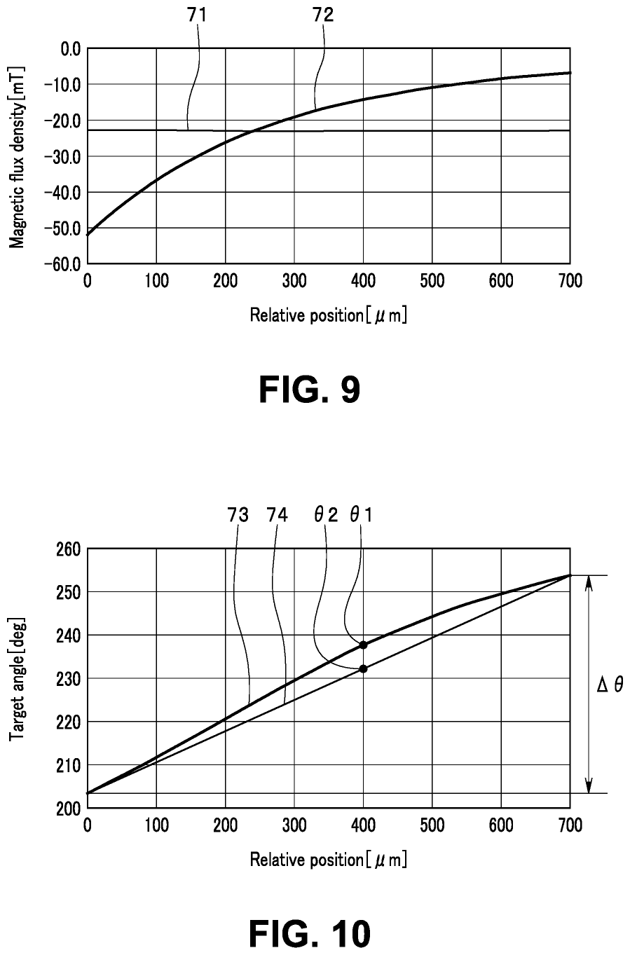

A relationship between the relative position and the target angle θ will now be described. FIG. 9 is a characteristic diagram showing a relationship between the relative position and the first and second magnetic field components MF1 and MF2. In FIG. 9, the horizontal axis represents the relative position, and the vertical axis the magnitudes of the magnetic flux densities corresponding to the strengths of the first and second magnetic field components MF1 and MF2. In FIG. 9, the reference numeral 71 denotes the magnetic flux density corresponding to the strength of the first magnetic field component MF1. The reference numeral 72 denotes the magnetic flux density corresponding to the strength of the second magnetic field component MF2. As illustrated in FIG. 9, when the relative position varies, the magnetic flux density 71 corresponding to the strength of the first magnetic field component MF1 does not vary but the magnetic flux density 72 corresponding to the strength of the second magnetic field component MF2 varies.

FIG. 10 is a characteristic diagram showing a relationship between the relative position and the target angle θ. In FIG. 10, the horizontal axis represents the relative position, and the vertical axis represents the target angle θ. In FIG. 10, the reference numeral 73 denotes a curve expressing the relationship between the relative position and the target angle θ. The reference numeral 74 denotes a line segment connecting both ends of the curve denoted by the reference numeral 73.

Now, a mode of variation in the target angle θ relative to variation in the relative position will be discussed. In the example embodiment, in a characteristic diagram expressing a relationship between two parameters like FIG. 10, a mode of variation where one parameter varies linearly or substantially linearly relative to variation in the other parameter will be referred to as “varying linearly”. In the characteristic diagram expressing the relationship between two parameters, a mode of variation where one parameter does not vary linearly or substantially linearly relative to the variation in the other parameter, like varying in a curved manner, will be referred to as “varying nonlinearly”.

In FIG. 10, the target angle θ varies in a curved manner relative to the variation in the relative position. In other words, in FIG. 10, the target angle θ varies nonlinearly relative to the variation in the relative position. The target angle θ varies within a first variable range corresponding to a movable range of the relative position.

In the example embodiment, the magnetic field generator 10 is configured so that a mode of variation in the direction of the target magnetic field MF relative to the variation in the relative position is such that the direction of the target magnetic field MF varies nonlinearly relative to the variation in the relative position. In other words, the magnetic field generator 10 is configured so that a mode of the variation in the target angle θ relative to the variation in the relative position is such that the target angle θ varies nonlinearly relative to the variation in the relative position. Whether the target angle θ varies linearly or nonlinearly is determined, for example, by the strengths of the first and second magnetic field components MF1 and MF2 within the movable range of the relative position. The strengths of the first and second magnetic field components MF1 and MF2 can be adjusted by the positions, characteristics, and other factors of the magnets 13, 31A, and 34A.

For example, the magnetic field generator 10 can be configured so that the target angle θ varies nonlinearly, on the basis of a first linearity parameter to be described below. In an orthogonal coordinate system where the position of the lens 5 and the target angle θ are represented by two orthogonal axes, a curve expressing a relationship between the position of the lens 5 and the target angle θ within the movable range of the lens 5 will be referred to as a first curve. A line segment connecting both ends of the first curve will be referred to as a first line segment. As described above, the relative position indicates the position of the lens 5. If the movable range of the relative position is 0 to 700 μm, the curve denoted by the reference numeral 73 in FIG. 10 corresponds to the first curve, and the line segment denoted by the reference numeral 74 in FIG. 10 corresponds to the first line segment. The value of the target angle θ corresponding to any relative position will be referred to as a first value θ1. The value corresponding to any relative position on the first line segment will be referred to as a second value θ2. FIG. 10 illustrates an example of the first and second values θ1 and θ2.

A difference between the maximum and minimum values of the target angle θ within the first variable range of the target angle θ will be referred to as a third value Δθ. FIG. 10 illustrates a third value Δθ in the case where the movable range of the relative position is 0 to 700 μm. The ratio of the difference between the first and second values θ1 and θ2 to the third value Δθ will be referred to as a first linearity parameter L1. The first linearity parameter L1 (in units of %) is expressed by the following Eq. (1):

$$L 1 = ( θ 1 - θ2 ) / Δθ \times 100 \qquad ( 1 )$$

The smaller the absolute value of the first linearity parameter L1, the more linearly the target angle θ varies relative to the variation in the relative position. If the absolute value of the first linearity parameter L1 is less than 3%, the target angle θ can be said to vary linearly or substantially linearly relative to the variation in the relative position. In the example embodiment, the magnetic field generator 10, i.e., the first and second magnetic field generation units 11 and 12 may be configured so that the absolute value of the first linearity parameter L1 is 3% or more, and further may be 10% or more, so that the target angle θ varies nonlinearly. In the example illustrated in FIG. 10, the absolute value of the first linearity parameter L1 is 11%.

On the other hand, if the absolute value of the first linearity parameter L1 is too large, a variation in the target angle θ becomes so large or so small compared to a variation in the relative position that the position of the lens 5 can no longer be accurately detected. To avoid this, the magnetic field generator 10, i.e., the first and second magnetic field generation units 11 and 12 may be configured so that the absolute value of the first linearity parameter L1 is 100% or less.

Next, a relationship between the relative position, the target angle θ, and the detection signal will be described. As describe above, the MR element 50 has a minimum resistance value when the angle that the second magnetization direction of the free layer 51 forms with the first magnetization direction of the magnetization pinned layer 53 is 0°, and a maximum resistance value when the angle is 180°. In each of the plurality of MR elements 50 included in the first resistor section R1, the angle that the second magnetization direction of the free layer 51 forms with the first direction that is the first magnetization direction of the magnetization pinned layer 53 will be referred to as a relative angle. The second magnetization direction of the free layer 51 varies with the direction of the target magnetic field MF. The relative angle thus varies with the direction of the target magnetic field MF and the target angle θ.

The first magnetization direction of the magnetization pinned layer 53 in each of the plurality of MR elements 50 included in the fourth resistor section R4 is the same direction (first direction) as the first magnetization direction of the magnetization pinned layer 53 in each of the plurality of MR elements 50 included in the first resistor section R1. In each of the plurality of MR elements 50 included in the fourth resistor section R4, the angle that the second magnetization direction of the free layer 51 forms with the first magnetization direction of the magnetization pinned layer 53 is therefore the same or substantially the same as the relative angle.

The first magnetization direction of the magnetization pinned layer 53 in each of the plurality of MR elements 50 included in the second resistor section R2 is opposite direction (second direction) to the first magnetization direction of the magnetization pinned layer 53 in each of the plurality of MR element 50 included in the first resistor section R1. In each of the plurality of MR elements 50 included in the second resistor section R2, the angle that the second magnetization direction of the free layer 51 forms with the first magnetization direction of the magnetization pinned layer 53 is therefore approximately 180° different from the relative angle.

The first magnetization direction of the magnetization pinned layer 53 in each of the plurality of MR elements 50 included in the third resistor section R3 is the same direction (second direction) as the first magnetization direction of the magnetization pinned layer 53 in each of the plurality of MR element 50 included in the second resistor section R2. In each of the plurality of MR elements 50 included in the third resistor section R3, the angle that the second magnetization direction of the free layer 51 forms with the first magnetization direction of the magnetization pinned layer 53 is therefore approximately 180° different from the relative angle.

In the example embodiment, the second magnetization direction of the free layer 51 coincides with the direction of the target magnetic field MF. The angle that the first direction forms with the X direction will be referred to as a first angle. The relative angle is obtained by subtracting the first angle from the target angle θ.

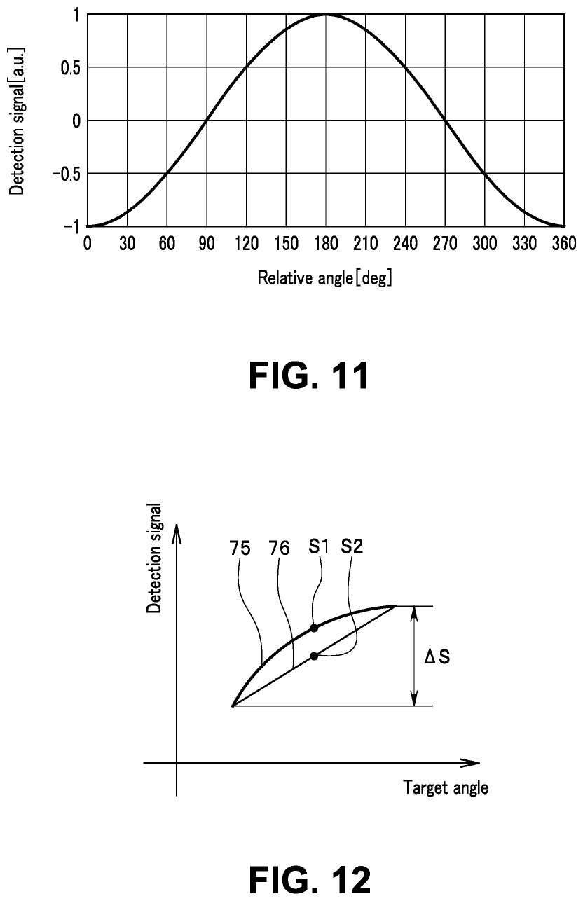

The magnetic sensor 20 is configured, for example, so that the detection signal has a minimum value when the relative angle is 0°, and a maximum value when the relative angle is 180°. FIG. 11 is a characteristic diagram showing a relationship between the relative angle and the detection signal. In FIG. 11, the horizontal axis represents the relative angle, and the vertical axis the detection signal. In FIG. 11, the detection signal is normalized so that the detection signal has a maximum value of 1 and a minimum value of −1.

In the example embodiment, the detection signal varies within a second variable range corresponding to the first variable range of the target angle θ. The magnetic sensor 20 is configured so that a mode of variation in the detection signal relative to variation in the relative angle is such that the detection signal varies nonlinearly relative to the variation in the direction of the target magnetic field MF. In particular in the example embodiment, the magnetic sensor 20 is configured so that a mode of the variation in the detection signal relative to the variation in the direction of the target magnetic field MF is such that the detection signal varies nonlinearly relative to the variation in the direction of the target magnetic field MF. In other words, the magnetic sensor 20 is configured so that a mode of the variation in the detection signal relative to the variation in the target angle θ is such that the detection signal varies nonlinearly relative to the variation in the target angle θ.

As can be seen from FIG. 11, whether the detection signal varies linearly or nonlinearly is determined by the range of the relative angle. The range of the relative angle is determined by the first variable range of the target angle θ and the first angle that the first direction forms with the X direction. The range of the relative angle can thus be adjusted by the first magnetization direction of the magnetization pinned layer 53.

For example, the magnetic sensor 20 can be configured so that the detection signal varies nonlinearly, on the basis of a second linearity parameter to be described below. In an orthogonal coordinate system where the target angle θ and the detection signal are represented by two orthogonal axes, a curve expressing a relationship between the target angle θ and the detection signal within the first variable range of the target angle θ will be referred to as a second curve. A line segment connecting both ends of the second curve will be referred to as a second line segment. FIG. 12 is a schematic diagram showing a relationship between the target angle θ and the detection signal. In FIG. 12, the horizontal axis represents the target angle θ, and the vertical axis the detection signal. In FIG. 12, the curve denoted by the reference numeral 75 represents the second curve. The line segment denoted by the reference numeral 76 represents the second line segment. The value of the detection signal corresponding to any target angle θ will be referred to as a fourth value S1. The value corresponding to any target angle θ on the second line segment will be referred to as a fifth value S2. FIG. 12 illustrates examples of the fourth and fifth values S1 and S2.

A difference between the maximum and minimum values of the detection signal within the second variable range of the detection signal will be referred to as a sixth value ΔS. The ratio of the difference between the fourth and fifth values S1 and S2 to the sixth value ΔS will be referred to as a second linearity parameter L2. The second linearity parameter L2 (in units of %) is expressed by the following Eq. (2):

$$L 2 = ( S 1 - S2 ) / Δ S \times 100 \qquad ( 2 )$$

The smaller the absolute value of the second linearity parameter L2, the more linearly the detection signal varies relative to the variation in the target angle θ. If the absolute value of the second linearity parameter L2 is less than 3%, the detection signal can be said to vary linearly or substantially linearly relative to the variation in the target angle θ. In the example embodiment, the first magnetization direction of the magnetic sensor 20, i.e., the magnetization pinned layer 53 may be configured so that the absolute value of the second linearity parameter L2 is 3% or more, more preferably 10% or more, so that the detection signal varies nonlinearly.

On the other hand, if the absolute value of the second linearity parameter L2 is too large, a variation in the detection signal becomes so large or so small compared to a variation in the target angle θ that the position of the lens 5 can no longer be accurately detected. To avoid this, the first magnetization direction of the magnetic sensor 20, i.e., the magnetization pinned layers 53 may be configured so that the absolute value of the second linearity parameter L2 is 100% or less.

In particular in the example embodiment, the magnetic sensor 20 includes the plurality of MR elements 50. In such a case, the magnetic sensor 20 can be configured so that the detection signal varies nonlinearly on the basis of the relative angle. The relative angle can be used instead of or in combination with the second linearity parameter L2.

Specifically, the magnetic sensor 20, i.e., the plurality of MR elements 50 are each configured so that the relative angle when the lens 5 is located at the center of the movable range falls within the range of 0° or more and 70° or less, within the range of 110° or more and 250° or less, or within the range of 290° or more and less than 360°. The relative angle when the lens 5 is located at the center of the movable range may further fall within the range of 10° or more and 60° or less, within the range of 120° or more and 170° or less, within the range of 190° or more and 240° or less, or within the range of 300° or more and 350° or less. As can be seen from FIG. 12, the detection signal varies nonlinearly relative to the variation in the relative angle within such ranges.

As described above, the relative angle refers to the angle that the second magnetization direction of the free layer 51 forms with the first direction that is the first magnetization direction of the magnetization pinned layer 53 in each of the plurality of MR elements 50 included in the first and fourth resistor sections R1 and R4. Now, in each of the plurality of MR elements 50 included in the second and third resistor sections R2 and R3, the angle that the second magnetization direction of the free layer 51 forms with the second direction that is the first magnetization direction of the magnetization pinned layer 53 will be referred to as a second angle. For example, if the relative angle when the lens 5 is located at the center of the movable range is in the range of 180° or more and 250° or less, the second angle when the lens 5 is located at the center of the movable range falls within the range of 0° or more and 70° or less. If the relative angle when the lens 5 is located at the center of the movable range is in the range of 290° or more and less than 360°, the second angle when the lens 5 is located at the center of the movable range falls within the range of 110° or more and 180° or less.

As described above, in the example embodiment, the magnetic field generator 10 is configured so that a mode of the variation in the direction of the target magnetic field MF relative to the variation in the position of the lens 5 is such that the direction of the target magnetic field MF varies nonlinearly relative to the variation in the position of the lens 5. In addition, the magnetic sensor 20 is configured so that a mode of the variation in the detection signal relative to the variation in the direction of the target magnetic field MF is such that the detection signal varies nonlinearly relative to the variation in the direction of the target magnetic field MF. According to the example embodiment, the detection signal can vary linearly relative to the variation in the position of the lens 5. In other words, according to the example embodiment, the detection signal can vary linearly relative to the variation in the position of the lens 5 even if the direction of the target magnetic field MF varies nonlinearly relative to the variation in the position of the lens 5.

An effect of the position detection device 1 according to the example embodiment will be described below in comparison with a position detection device of a first comparative example. A configuration of the position detection device of the first comparative example will initially be described. The position detection device of the first comparative example has basically the same configuration as that of the position detection device 1 according to the example embodiment. In the first comparative example, the relative angle when the lens 5 is located at the center of the movable range is 90°.

Next, a configuration of a position detection device of a first practical example corresponding to the position detection device 1 according to the example embodiment will be described. The position detection device of the first practical example has basically the same configuration as that of the position detection device 1 according to the example embodiment. In the first practical example, the relative angle when the lens 5 is located at the center of the movable range is 127°.

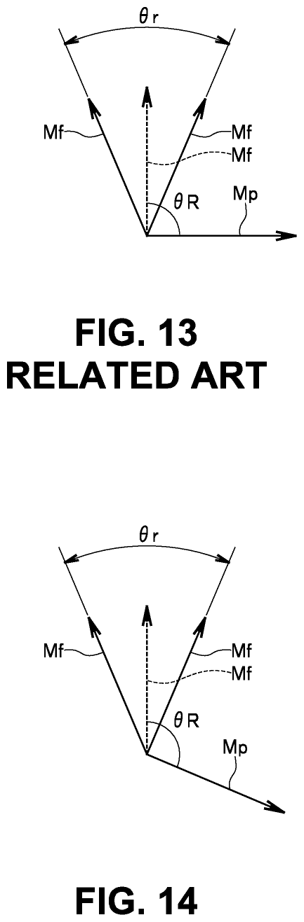

FIG. 13 is an explanatory diagram showing the first and second magnetization directions in the position detection device of the first comparative example. FIG. 14 is an explanatory diagram showing the first and second magnetization directions in the position detection device of the first practical example. FIGS. 13 and 14 illustrate the first and second magnetization directions in each of the plurality of MR elements 50 included in the first and fourth resistor sections R1 and R4. In FIGS. 13 and 14, the arrow denoted by the symbol Mp indicates the first magnetization direction (first direction) of the magnetization pinned layer 53. The arrows denoted by the symbol Mf indicate the second magnetization direction of the free layer 51. In FIGS. 13 and 14, the arrow denoted by the symbol Or indicates the variable range of the first magnetization direction corresponding to the movable range of the lens 5. The broken-lined arrow denoted by the symbol Mf indicates the first magnetization direction when the lens 5 is located at the center of the movable range.

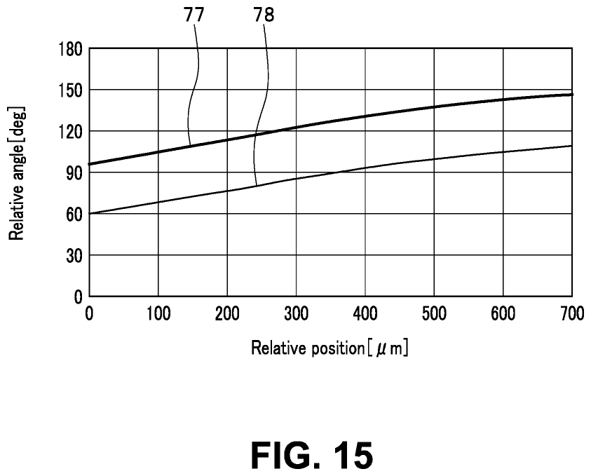

FIG. 15 is a characteristic diagram showing a relationship between the relative position and the relative angle. In FIG. 15, the horizontal axis represents the relative position, and the vertical axis the relative angle. In FIG. 15, the reference numeral 77 denotes the relative angle in the first practical example, and the reference numeral 78 the relative angle in the first comparative example. In the first comparative example and the first practical example, the movable range of the relative position is 0 to 700 μm.

Now, a third linearity parameter L3 will be defined as a parameter representing a mode of the variation in the detection signal relative to the variation in the position of the lens 5, i.e., the variation in the relative position. The definition of the third linearity parameter L3 is basically the same as that of the second linearity parameter L2 described with reference to FIG. 12. The definition of the third linearity parameter L3 is given by replacing the target angle θ and the first variable range in the description of the definition of the second linearity parameter L2 with the relative position and the movable range, respectively. The smaller the absolute value of the third linearity parameter L3, the more linearly the detection signal varies relative to the variation in the relative position.

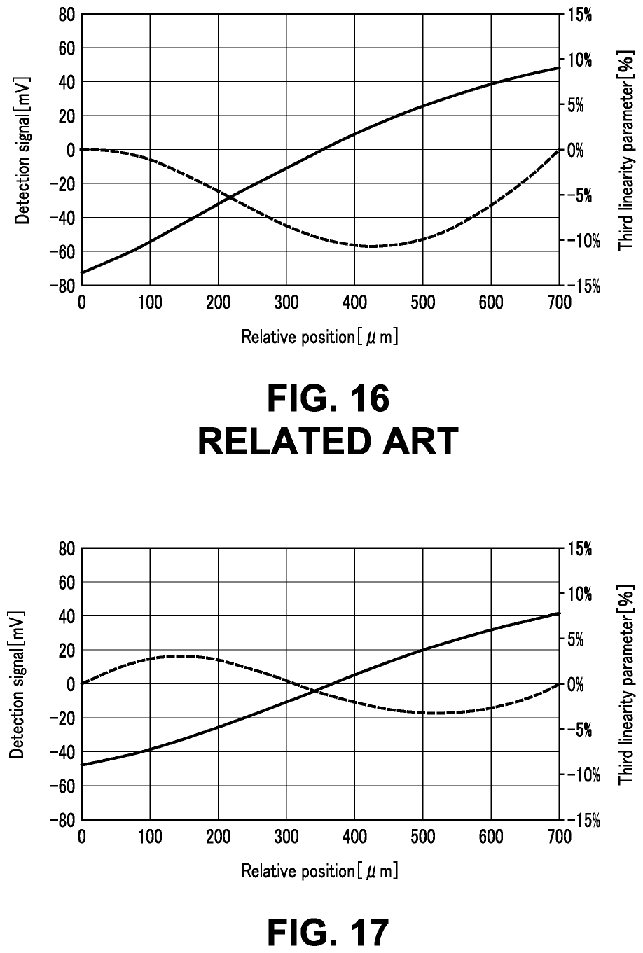

FIG. 16 is a characteristic diagram showing a relationship between the relative position and the detection signal, and between the relative position and the third linearity parameter L3 of the position detection device of the first comparative example. FIG. 17 is a characteristic diagram showing a relationship between the relative position and the detection signal, and between the relative position and the third linearity parameter L3 of the position detection device of the first practical example. In FIGS. 16 and 17, the horizontal axis represents the relative position. The vertical axis on the left represents the detection signal, and the vertical axis on the right the third linearity parameter L3. In FIGS. 16 and 17, a solid-lined curve represents the detection signal, and a broken-lined curve the third linearity parameter L3.

As illustrated in FIG. 16, in the first comparative example, the maximum absolute value of the third linearity parameter L3 was 11%. As illustrated in FIG. 17, in the first practical example, the maximum absolute value of the third linearity parameter L3 was 3%. As can be seen from FIGS. 16 and 17, according to the example embodiment, the detection signal can vary linearly relative to the variation in the relative position, i.e., the variation in the position of the lens 5, compared to the first comparative example.

Next, other effects of the example embodiment will be described. In the example embodiment, the relative angle when the lens 5 is located at the center of the movable range is set to within the range of 0° or more and 70° or less, within the range of 110° or more and 250° or less, or within the range of 290° or more and less than 360°. If the relative angle is 0° or in its vicinity, or 180° or in its vicinity, a variation in the detection signal becomes small compared to a variation in the relative angle. By setting the relative angle to any one of the foregoing preferable ranges to exclude a relative angle of 0° and its vicinity, or a relative angle of 180° and its vicinity, a variation in the detection signal can be prevented from becoming small compared to a variation in the relative angle.

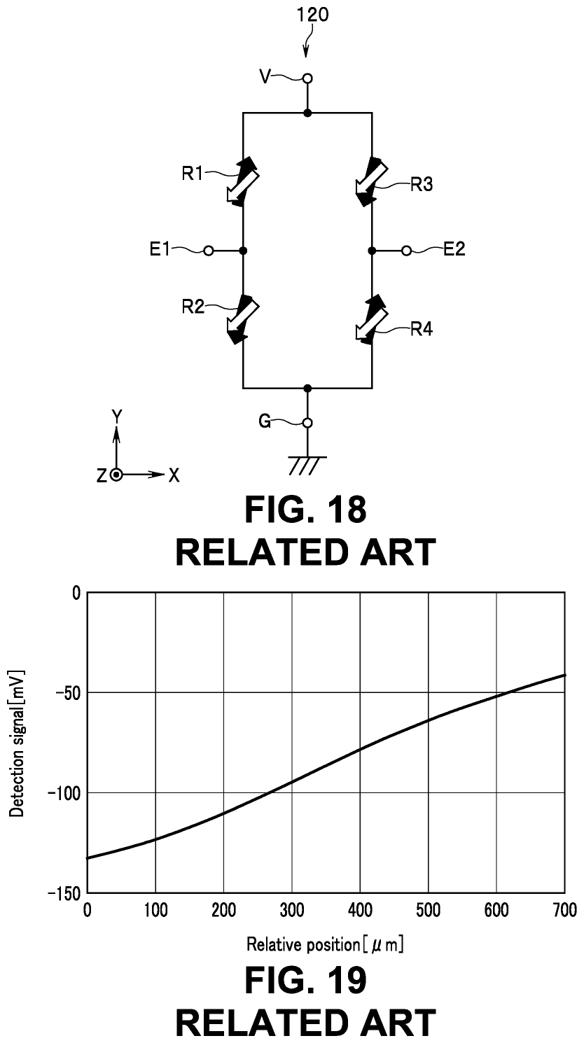

In the example embodiment, the magnetic sensor 20 includes the first and second resistors Ro1 and Ro2. According to the example embodiment, the offset of the detection signal can thereby be reduced. This effect will be described below in comparison with a position detection device of a second comparative example. A configuration of the position detection device of the second comparative example will initially be described. The position detection device of the second comparative example includes a magnetic sensor 120 instead of the magnetic sensor 20 in the example embodiment. FIG. 18 is a circuit diagram showing a configuration of the magnetic sensor 120. The magnetic sensor 120 does not include the first and second resistor Ro1 and Ro2 in the example embodiment. The rest of the configuration of the position detection device of the second comparative example is the same as that of the position detection device 1 according to the example embodiment.

FIG. 19 is a characteristic diagram showing a relationship between the relative position and the detection signal in the position detection device of the second comparative example. In FIG. 19, the horizontal axis represents the relative position, and the vertical axis the detection signal. As illustrated in FIG. 19, in the second comparative example, the detection signal is weak compared to the detection signal in the first practical example illustrated in FIG. 17. A deviation of the detection signal when the lens 5 is located at the center of the movable range from a predetermined reference value will hereinafter be referred to as an offset of the detection signal, or simply as an offset. An example of the predetermined reference value is 0. FIG. 19 illustrates that in the second comparative example, the detection signal has an offset greater than that of the detection signal in the first practical example.

For example, the detection signal is input to a not-illustrated processor and predetermined processing. The not-illustrated processor includes, for example, an application specific integrated circuit (ASIC) or microcomputer, and includes an analog-to-digital converter (hereinafter, referred to as an A/D converter) for converting the detection signal into a digital signal. The use range of the detection signal in the not-illustrated processor is defined in advance. For example, the use range is the range of normal input signals to the A/D converter. As illustrated in FIG. 19, if the offset of the detection signal is large, the value of the detection signal can go out of the use range even within the second variable range. In such a case, the position of the lens 5 is unable to be detected.

As illustrated in FIG. 11, the detection signal is 0 when the relative angle is 90° or 270°. As describe above, the reason why the detection signal has a large offset is that the relative angle when the lens 5 is located at the center of the movable range is other than 90° or 270°. By contrast, in the example embodiment, the offset of the detection signal is reduced by adjusting the electric potentials of the output ports E1 and E2 with the first and second resistors Ro1 and Ro2. According to the example embodiment, the value of the detection signal can thereby be prevented from going out of the use range.

### Second Example Embodiment

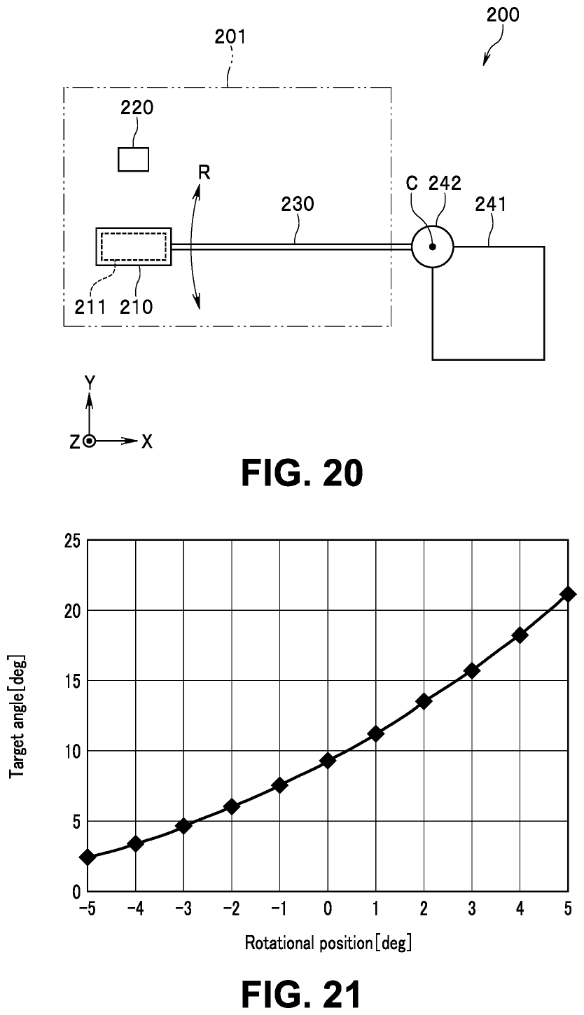

A second example embodiment of the technology will now be described. A configuration of a rotary actuator according to the second example embodiment of the technology will initially be described with reference to FIG. 20. FIG. 20 is a plan view showing a rotary actuator 200.

The rotary actuator 200 according to the example embodiment includes a position detection device 201 according to the example embodiment, a main body 241, and a rotating body 242. The position detection device 201 according to the example embodiment is a magnetic position detection device and used to detect the rotational position of the rotating body 242. The main body 241 includes a not-illustrated driving device including a servo motor, for example. The not-illustrated driving device rotates the rotating body 242 in a direction of rotation R about a predetermined rotation axis C. The not-illustrated driving device is controlled by a not-illustrated control unit external to the rotary actuator 200.

FIG. 20 illustrates an X direction, a Y direction, and a Z direction like FIGS. 6 and 7 in the first example embodiment. In the example embodiment, a direction that is parallel to the rotation axis C and directed from the far side to the near side of FIG. 20 is defined as the Z direction. In FIG. 20, the X direction is illustrated as a rightward direction, and the Y direction an upward direction.

The position detection device 201 includes a magnetic field generator 210, a magnetic sensor 220, and a connection member 230. The connection member 230 connects the magnetic field generator 210 to the rotating body 242. As the rotating body 242 rotates, the position of the magnetic field generator 210 varies in the direction of rotation R about the rotation axis C. The magnetic field generator 210 generates a target magnetic field that is the magnetic field for the magnetic sensor 220 to detect (magnetic field to be detected). In the example embodiment, the magnetic field generator 210 includes a magnet 211 for generating the target magnetic field.

The magnetic sensor 220 detects the target magnetic field at a detection position in a reference plane, and generates a detection signal corresponding to the direction of the target magnetic field. The magnetic sensor 220 is fixed to near the magnetic field generator 210 by a not-illustrated fixing member. The detection position refers to a position where the magnetic sensor 220 detects the target magnetic field. The reference plane is a plane that contains the detection position and is perpendicular to the Z direction. The magnetic sensor 220 has the same configuration as that of the magnetic sensor 20 of the first example embodiment.

The magnetic field generator 210 is configured so that the direction and strength of the target magnetic field at the detection position in the reference plane vary when the rotational position of the rotating body 242 varies. When the position of the magnetic field generator 210 varies with variation in the rotational position of the rotating body 242, the direction and strength of the target magnetic field at the detection position vary and the value of the detection signal generated by the magnetic sensor 220 varies accordingly. The value of the detection signal varies depending on the rotational position of the rotating body 242. The not-illustrated control unit detects the rotational position of the rotating body 242 by measuring the detection signal. Like the magnetic sensor 20 of the first example embodiment, the magnetic sensor 220 generates the detection signal corresponding to a target angle that the direction of the target magnetic field forms with a reference direction.

The rotational position of the rotating body 242 will hereinafter be referred to simply as a rotational position. In the example embodiment, the rotational position is expressed by the rotation angle of the rotating body 242. The rotational position (rotation angle) when the rotating body 242 is located at the center of the movable range is 0°. The rotational position is expressed in positive angle values if the rotating body 242 is rotated in one direction along the direction of rotation R from the state where the rotation position is 0°. The rotation position is expressed in negative angle values if the rotating body 242 is rotated in a direction opposite to the foregoing one direction along the direction of rotation R from the state where the rotation position is 0°. The movable range of the rotational position is less than 90°, for example.

FIG. 21 is a characteristic diagram showing a relationship between the rotational position and the target angle. In FIG. 21, the horizontal axis represents the rotational position, and the vertical axis the target angle. In FIG. 21, the target angle varies in a curved manner relative to the variation in the rotational position. In FIG. 21, the target angle thus varies nonlinearly relative to the variation in the rotational position. The target angle varies within a first variable range corresponding to the movable range of the rotational position.

In the example embodiment, the magnetic field generator 210 is configured so that a mode of variation in the direction of the target magnetic field relative to variation in the rotational position is such that the direction of the target magnetic field varies nonlinearly relative to the variation in the rotation position. In other words, the magnetic field generator 210 is configured so that a mode of variation in the target angle relative to the variation in the rotation position is such that the target angle varies nonlinearly relative to the variation in the rotation position. Whether the target angle varies linearly or nonlinearly is determined, for example, by the magnetization direction of the magnet 211 in the magnetic field generator 210 and the position of the magnetic field generator 210 relative to the magnetic sensor 220.

The magnetic field generator 210 can be configured so that the target angle varies nonlinearly, for example, on the basis of the first linearity parameter L1 described in the first example embodiment. The first linearity parameter L1 in the example embodiment is defined in the following manner. Initially, in an orthogonal coordinate system where the rotational position and the target angle are represented by two orthogonal axes, a curve representing the relationship between the rotational position and the target angle within the movable range of the rotational position will be referred to as a first curve. A line segment connecting both ends of the first curve will be referred to as a first line segment. A value of the target angle corresponding to any rotational position will be referred to as a first value θ1. A value corresponding to any rotational position on the first line segment will be referred to as a second value θ2. A difference between the maximum and minimum values of the target angle within the first variable range of the target angle will be referred to as a third value Δθ. The ratio of the difference between the first and second values θ1 and θ2 to the third value Δθ is defined as the first linearity parameter L1 corresponding to the first value θ1. The first linearity parameter L1 is expressed by Eq. (1) in the first example embodiment.

In the example embodiment, the magnetic field generator 210 is configured so that the absolute value of the first linearity parameter L1 is 3% or more and 100% or less. Like the first example embodiment, the magnetic field generator 210 may be configured so that the absolute value of the first linearity parameter L1 is 10% or more.

As described in the first example embodiment, in each of the plurality of MR elements 50 (see FIG. 8) included in the first and fourth resistor sections R1 and R4 (see FIG. 7) of the magnetic sensor 220, the angle that the second magnetization direction of the free layer 51 forms with the first direction that is the first magnetization direction of the magnetization pinned layer 53 will be referred to as a relative angle. In the example embodiment, like the first example embodiment, the second magnetization direction of the free layer 51 coincides with the direction of the target magnetic field MF.

The magnetic sensor 220 is configured so that a mode of variation in the detection signal relative to variation in the relative angle is such that the detection signal varies nonlinearly relative to the variation in the direction of the target magnetic field. In particular in the example embodiment, the magnetic sensor 220 is configured so that a mode of the variation in the detection signal relative to the variation in the direction of the target magnetic field is such that the detection signal varies nonlinearly relative to the variation in the direction of the target magnetic field. In other words, the magnetic sensor 220 is configured so that a mode of the variation in the detection signal relative to the variation in the target angle is such that the detection signal varies nonlinearly relative to the variation in the target angle.

As described in the first example embodiment, whether the detection signal varies linearly or nonlinearly is determined by the range of the relative angle. The range of the relative angle can be adjusted by the first magnetization direction of the magnetization pinned layer 53.

The magnetic sensor 220 can be configured so that the detection signal varies nonlinearly, for example, on the basis of the second linearity parameter L2 described in the first example embodiment. The definition of the second linearity parameter L2 in the example embodiment is the same as in the first example embodiment. In the example embodiment, the first magnetization direction of the magnetic sensor 220, i.e., the magnetization pinned layers 53 is configured so that the absolute value of the second linearity parameter L2 is 3% or more and 100% or less. Like the first example embodiment, the first magnetization direction of the magnetic sensor 220, i.e., the magnetization pinned layers 53 may be configured so that the absolute value of the second linearity parameter L2 is 10% or more.

In particular in the example embodiment, the magnetic sensor 220 includes the plurality of MR elements 50. In such a case, the magnetic sensor 220 can be configured so that the detection signal varies nonlinearly on the basis of the relative angle. The relative angle can be used instead of or in combination with the second linearity parameter L2.

Specifically, the magnetic sensor 220, i.e., each of the plurality of MR elements 50, is configured so that the relative angle when the rotating body 242 is located at the center of the movable range of the rotational position falls within the range of 0° or more and 70° or less, within the range of 110° or more and 250° or less, or within the range of 290° or more and less than 360º. The relative angle when the rotating body 242 is located at the center of the movable range of the rotational position may further fall within the range of 10° or more and 60° or less, within the range of 120° or more and 170° or less, within the range of 190° or more and 240° or less, or within the range of 300° or more and 350° or less.

As described above, in the example embodiment, the magnetic field generator 210 is configured so that a mode of the variation in the direction of the target magnetic field relative to the variation in the rotational position of the rotating body 242 is such that the direction of the target magnetic field varies nonlinearly relative to the variation in the rotational position of the rotating body 242. In addition, the magnetic sensor 220 is configured so that a mode of the variation in the detection signal relative to the variation in the direction of the target magnetic field is such that the detection signal varies nonlinearly relative to the variation in the direction of the target magnetic field. According to the example embodiment, the detection signal can vary linearly relative to the variation in the position of the rotating body 242. In other words, according to the example embodiment, the detection signal can vary linearly relative to the variation in the rotational position of the rotating body 242 even if the direction of the target magnetic field varies nonlinearly relative to the variation in the rotational position of the rotating body 242.

An effect of the position detection device 201 according to the example embodiment will be described below in comparison with a position detection device of a third comparative example. A configuration of the position detection device of the third comparative example will initially be described. The position detection device of the third comparative example has basically the same configuration as that of the position detection device 201 according to the example embodiment. In the third comparative example, the relative angle when the rotating body 242 is located at the center of the movable range is 90°. The third comparative example does not include the first and second resistor Ro1 and Ro2 (see FIG. 7).

Next, a configuration of a position detection device of a second practical example will be described. The position detection device of the second practical example has basically the same configuration as that of the position detection device 201 according to the example embodiment. In the second practical example, the relative angle when the rotating body 242 is located at the center of the movable range is 153°. The second practical example does not include the first and second resistor Ro1 and Ro2 (see FIG. 7).

In the example embodiment, the third linearity parameter L3 described in the first example embodiment is used as a parameter representing a mode of the variation in the detection signal relative to the variation in the rotational position. The definition of the third linearity parameter L3 is basically the same as that of the second linearity parameter L2 described in the first example embodiment. The definition of the third linearity parameter L3 of the example embodiment is given by replacing the target angle θ and the first variable range in the description of the definition of the second linearity parameter L2 with the rotational position and the movable range, respectively. The smaller the absolute value of the third linearity parameter L3, the more linearly the detection signal varies relative to the variation in the rotational position.

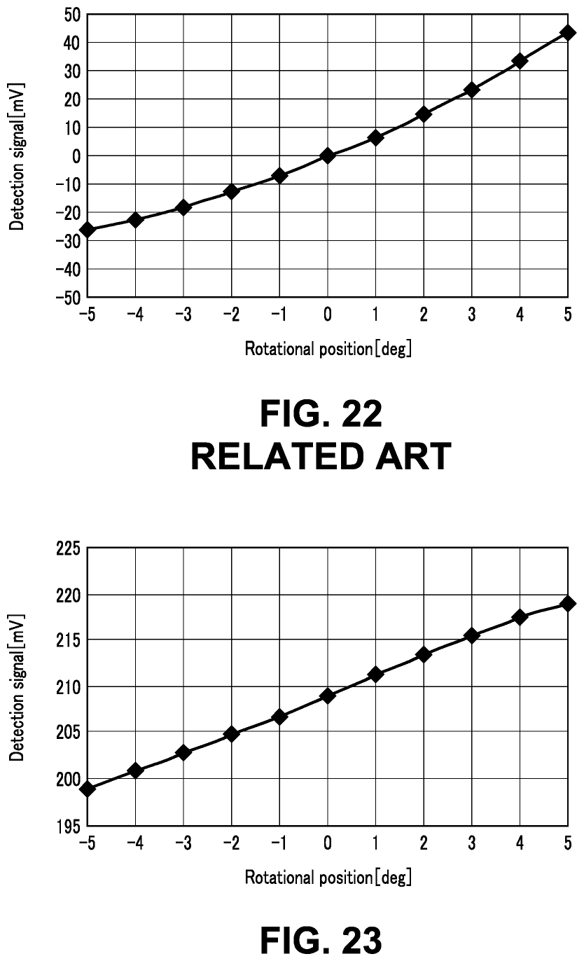

FIG. 22 is a characteristic diagram showing a relationship between the rotational position and the detection signal in the position detection device of the third comparative example. FIG. 23 is a characteristic diagram showing a relationship between the rotational position and the detection signal in the position detection device of the second practical example. In FIGS. 22 and 23, the horizontal axis represents the rotational position, and the vertical axis the detection signal. In the third comparative example and the second practical example, the movable range of the rotational position is −5° to 5°.

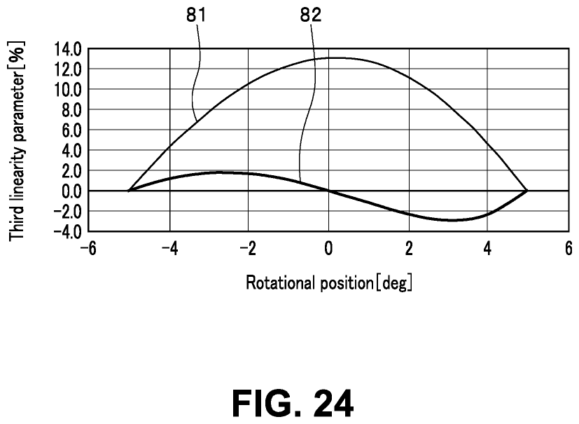

FIG. 24 is a characteristic diagram showing a relationship between the rotational position and the third linearity parameter L3. In FIG. 24, the horizontal axis represents the rotational position, and the vertical axis the third linearity parameter L3. In FIG. 24, the curve denoted by the reference numeral 81 represents the third linearity parameter L3 of the third comparative example. The curve denoted by the reference numeral 82 represents the third linearity parameter L3 of the second practical example. As illustrated in FIG. 24, in the third comparative example, the maximum absolute value of the third linearity parameter L3 was 13%. In the second practical example, the maximum absolute value of the third linearity parameter L3 was 3%. As can be seen from FIG. 24, according to the example embodiment, the detection signal can vary linearly relative to the variation in the rotational position, compared to the third comparative example.

The configurations, operation, and effects of the example embodiment are otherwise the same as those of the first example embodiment.

### Third Example Embodiment

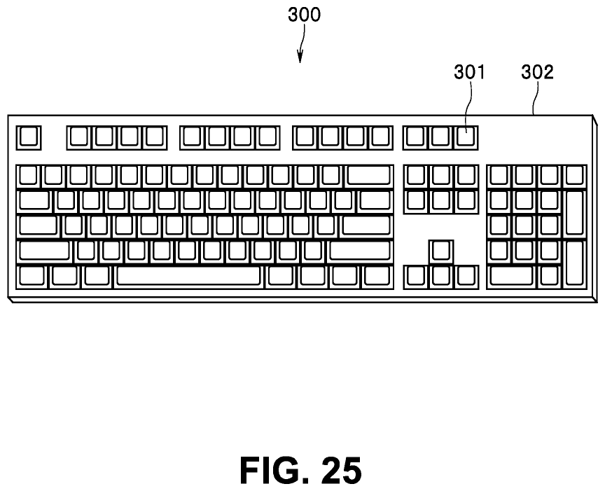

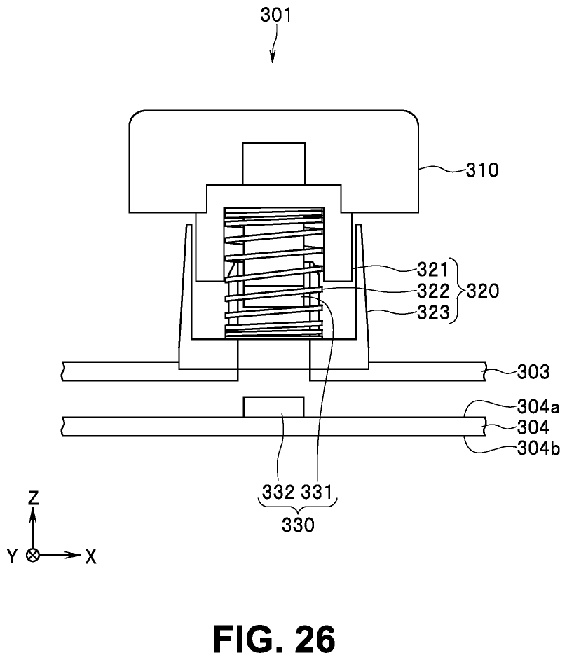

Next, a third example embodiment of the technology will be described. First, a schematic configuration of a keyboard according to the example embodiment will be described with reference to FIGS. 25 and 26. FIG. 25 is a plan view showing the keyboard according to the example embodiment. FIG. 26 is a side view showing a key switch according to the example embodiment.

A keyboard 300 according to the example embodiment is used, for example, as a keyboard for a personal computer. The keyboard 300 includes a plurality of key switches 301 constituting a plurality of keys of the keyboard 300, a case 302, and a switch plate 303 and a substrate 304 that are provided within the case 302. The plurality of key switches 301 are secured to the switch plate 303. The substrate 304 is arranged at a predetermined distance from the switch plate 303, and has a top surface 304a facing the switch plate 303 and a bottom surface 304b on an opposite side of the top surface 304a.

A configuration of the key switch 301 according to the example embodiment will now be described with reference to FIG. 26. The key switch 301 includes a key cap 310, a holding member 320 configured to hold the key cap 310 while allowing the key cap 310 to move linearly, and a position detection device 330 for detecting a position of the key cap 310. The key cap 310 corresponds to an ‘object’ in the technology.

Here, X, Y, and Z directions are defined as shown in FIG. 26. The X, Y, and Z directions are orthogonal to one another. In the example embodiment, the Z direction is one direction perpendicular to the top surface 304a of the substrate 304 (in FIG. 26, an upward direction). The position of the key cap 310 varies in a direction parallel to the Z direction.

The holding member 320 includes a stem 321 to which the key cap 310 is fixed, a spring 322, and a housing 323. The housing 323 accommodates a part of the stem 321 and the spring 322 and is fixed to the switch plate 303. The housing 323 may, for example, be fitted into a fitting hole provided in the switch plate 303.

The spring 322 is a compression coil spring. The stem 321, the spring 322, and the housing 323 are configured to hold the key cap 310 at a predetermined position. The stem 321, the spring 322, and the housing 323 are configured such that when a depressing force in the −Z direction is applied to the key cap 310, a biasing force in the direction opposite to the depressing force, i.e., in the Z direction, is applied to the key cap 310. The stem 321, the spring 322, and the housing 323 are configured to return the key cap 310 to the above-mentioned predetermined position when the depressing force is no longer applied to the key cap 310.

Operation of the spring 322 will be described below. When the depressing force in the −Z direction is applied to the key cap 310, a restoring force of the spring 322 is applied to the key cap 310 via the stem 321. When the depressing force is no longer applied to the key cap 310, the restoring force of the spring 322 returns the position of the key cap 310 to the predetermined position, i.e., a stationary position in a state where no depressing force is applied to the key cap 310.

In an example shown in FIG. 26, the key switch 301 has a structure similar to a so-called mechanical switch. However, the key switch 301 may have other structures, such as a pantograph structure.

The position detection device 330 includes a magnetic field generator 331 and a magnetic sensor 332. The magnetic field generator 331 is fixed, for example, to an end portion of the stem 321 in the −Z direction. The position of the magnetic field generator 331 varies in a direction parallel to the Z direction by the depressing force and the biasing force that are applied to the key cap 310. The magnetic field generator 331 generates a target magnetic field, which is a magnetic field for the magnetic sensor 332 to detect (magnetic field to be detected). The magnetic field generator 331 may be, for example, a magnet magnetized in a direction parallel to the X direction.

The magnetic sensor 332 detects the target magnetic field at a detection position in a reference plane and generates a detection signal corresponding to variation in the target magnetic field. The magnetic sensor 332 is fixed to the top surface 304a of the substrate 304. Note that the magnetic sensor 332 may be fixed to the bottom surface 304b of the substrate 304. The magnetic sensor 332 may be arranged to overlap the magnetic field generator 331 when seen in the Z direction. The expression ‘when seen in the Z direction’ means that an object is seen from a position away in the Z direction.

The detection position may be a position at which the magnetic sensor 332 detects the target magnetic field. The reference plane may be a plane that contains the detection position and is perpendicular to the Z direction. A configuration of the magnetic sensor 332 is basically the same as the configuration of the magnetic sensor 20 in the first example embodiment. In particular in the example embodiment, the magnetic sensor 332 may be configured to detect at least a component of the target magnetic field in a direction parallel to the X direction.

Note that the magnetic sensor 20 in the first example embodiment is configured to detect the composite magnetic field of the first magnetic field component MF1 and the second magnetic field component MF2. The magnetic sensor 332 in the example embodiment may be configured to detect a composite magnetic field of two magnetic field components, similar to the magnetic sensor 20. One of the two magnetic field components may be a magnetic field component generated by the magnetic field generator 331. The magnetic field component generated by the magnetic field generator 331 corresponds, for example, to the second magnetic field component MF2 in the first example embodiment. In other words, when the position of the magnetic field generator 331 relative to the substrate 304 varies, a direction of the magnetic field component generated by the magnetic field generator 331 does not vary, but the strength of the magnetic field component generated by the magnetic field generator 331 varies.

The other of the two magnetic field components may be a bias magnetic field component applied to the free layer 51 of the MR element 50. The bias magnetic field component may be a component in a direction that intersects the first magnetization direction of the magnetization pinned layer 53 of the MR element 50. The bias magnetic field component corresponds, for example, to the first magnetic field component MF1 in the first example embodiment. In other words, the direction and strength of the bias magnetic field component do not vary even if the position of the magnetic field generator 331 relative to the substrate 304 varies.

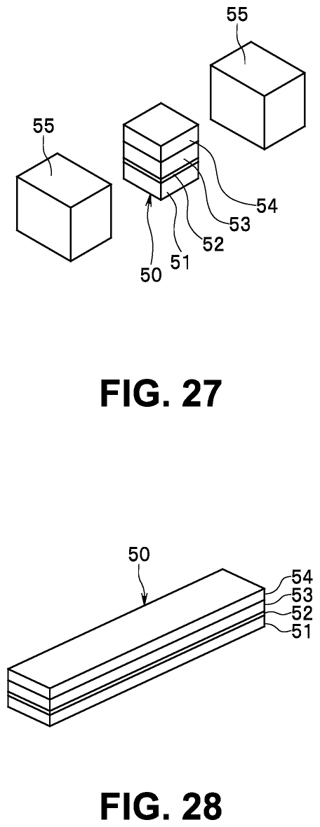

The bias magnetic field component may be a component of a magnetic field generated by a bias magnet provided near the MR element 50. FIG. 27 shows the MR element 50 and two bias magnets 55 disposed with the MR element 50 interposed therebetween. Alternatively, the bias magnetic field component may be due to a shape magnetic anisotropy set in the free layer 51. FIG. 28 shows the MR element 50 including the free layer 51 with the shape magnetic anisotropy set.

The magnetic field generator 331 is configured such that the target magnetic field at the detection position in the reference plane varies when the position of the key cap 310 varies. The direction and strength of the target magnetic field can be expressed as a vector. When the position of the key cap 310 varies, the direction and strength of the target magnetic field at the detection position, i.e., the vector expressing the target magnetic field, varies. When the target magnetic field (vector) at the detection position varies, the value of the detection signal generated by the magnetic sensor 332 also varies. The value of the detection signal varies depending on the position of the key cap 310. A not-illustrated control unit detects the position of the key cap 310 by measuring the detection signal. The magnetic sensor 332 generates a detection signal corresponding to variation in the target magnetic field (variation in the vector). Note that the variation in the target magnetic field (vector) is specifically variation in at least one of the strength and direction of the target magnetic field.

In the example embodiment, the target magnetic field varies nonlinearly relative to variation in the position of the key cap 310. The target angle that the target magnetic field forms with the reference direction varies within a first variable range corresponding to the movable range of the key cap 310.

The magnetic field generator 331 is configured so that a mode of the variation in the target magnetic field relative to the variation in the position of the key cap 310 is such that the target magnetic field varies nonlinearly relative to the variation in the position of the key cap 310. Whether the target magnetic field varies linearly or nonlinearly is determined by the strength of the target magnetic field in the movable range of the key cap 310, for example. The strength of the target magnetic field can be adjusted by the position and characteristics of the magnets constituting the magnetic field generator 331. The magnetic field generator 331 can be configured such that the target magnetic field varies nonlinearly using, for example, a parameter similar to the first linearity parameter described in the first example embodiment.

The detection signal varies within a second variable range corresponding to the first variable range of the target angle. The magnetic sensor 332 is configured so that a mode of variation in the detection signal relative to the variation in the target magnetic is such that the detection signal varies nonlinearly relative to the variation in the target magnetic field. The magnetic sensor 332 may be configured so that a mode of the variation in the detection signal relative to variation in the target angle is such that the detection signal varies nonlinearly relative to the variation in the target angle.

Whether the detection signal varies linearly or nonlinearly can be adjusted by the first magnetization direction of the magnetization pinned layer 53 of the MR element 50, as in the first example embodiment. The magnetic sensor 332 can be configured so that the detection signal varies nonlinearly, for example, using a parameter similar to the second linearity parameter described in the first example embodiment.

As described above, in the example embodiment, the magnetic field generator 331 is configured so that the mode of the variation in the target magnetic field relative to the variation in the position of the key cap 310 is such that the target magnetic field varies nonlinearly relative to the variation in the position of the key cap 310, and the magnetic sensor 332 is configured so that the mode of the variation in the detection signal relative to the variation in the target magnetic field is such that the detection signal varies nonlinearly relative to the variation in the target magnetic field. According to the example embodiment, this allows the detection signal to vary linearly relative to the variation in the position of the key cap 310. In other words, according to the example embodiment, the detection signal can vary linearly relative to the variation in the position of the key cap 310, even if the target magnetic field varies nonlinearly relative to the variation in the position of the key cap 310.

Other configurations, operation, and effects in the example embodiment are the same as in the first example embodiment.

### Fourth Example Embodiment

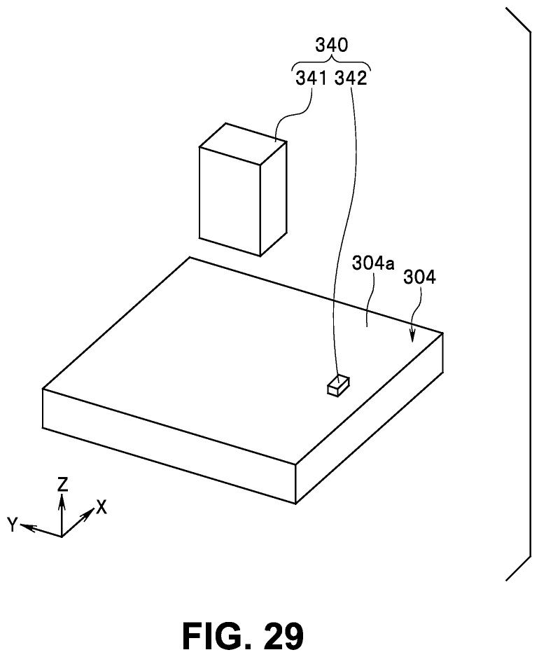

A fourth example embodiment of the technology will now be described with reference to FIG. 29. FIG. 29 is a perspective view showing a position detection device according to the example embodiment.

A position detection device 340 according to the example embodiment differs from the position detection device 330 according to the third example embodiment in the following respects. The position detection device 340 includes a magnetic field generator 341 and a magnetic sensor 342. The magnetic sensor 342 is arranged not to overlap the magnetic field generator 341 when seen in the Z direction.

The magnetic field generator 341 is fixed, for example, to an end portion of the stem 321 shown in FIG. 26 in the third example embodiment in the −Z direction. A position of the magnetic field generator 341 varies in a direction parallel to the Z direction by a depressing force and a biasing force applied to the key cap 310. The magnetic field generator 341 generates a target magnetic field, which is a magnetic field for the magnetic sensor 342 to detect (magnetic field to be detected). The magnetic field generator 341 may be, for example, a magnet magnetized in a direction parallel to the Y direction or a magnet magnetized in a direction parallel to the Z direction.

The magnetic sensor 342 detects the target magnetic field at a detection position in the reference plane and generates a detection signal corresponding to variation in the target magnetic field. A configuration of the magnetic sensor 342 is basically the same as the configuration of the magnetic sensor 332 in the third example embodiment. In particular in the example embodiment, the magnetic sensor 342 may be configured to detect at least a component of the target magnetic field in a direction parallel to the Y direction.

Note that, like the magnetic sensor 332, the magnetic sensor 342 in the example embodiment may be configured to detect a composite magnetic field of two magnetic field components. One of the two magnetic field components may be a magnetic field component generated by the magnetic field generator 341. The magnetic field component generated by the magnetic field generator 341 corresponds, for example, to the second magnetic field component MF2 in the first example embodiment. In other words, when a position of the magnetic field generator 341 relative to the substrate 304 varies, the direction of the magnetic field component generated by the magnetic field generator 341 does not vary, but the strength of the magnetic field component generated by the magnetic field generator 341 varies.

The other of the two magnetic field components may be a bias magnetic field component to be applied to the MR element 50. The bias magnetic field component may be a component in a direction orthogonal to the first magnetization direction of the magnetization pinned layer 53 of the MR element 50. The bias magnetic field component corresponds, for example, to the first magnetic field component MF1 in the first example embodiment. In other words, the direction and strength of the bias magnetic field component do not vary even if the position of the magnetic field generator 341 relative to the substrate 304 varies. The bias magnetic field component may be a magnetic field component generated by the bias magnet 55 provided near the MR element 50, or may be due to the shape magnetic anisotropy set in the free layer 51, as in the third example embodiment.

Other configurations in the position detection device 340 are similar to the configuration of the position detection device 330 according to the third example embodiment. As in the third example embodiment, the magnetic field generator 341 is configured so that a mode of the variation in the target magnetic field relative to variation in the position of the key cap 310 is such that the target magnetic field varies nonlinearly relative to the variation in the position of the key cap 310, and the magnetic sensor 342 is configured so that a mode of variation in the detection signal relative to the variation in the target magnetic field is such that the detection signal varies nonlinearly relative to the variation in the target magnetic field.

Other configurations, operation, and effects in the example embodiment are the same as in the third example embodiment.

### Fifth Example Embodiment

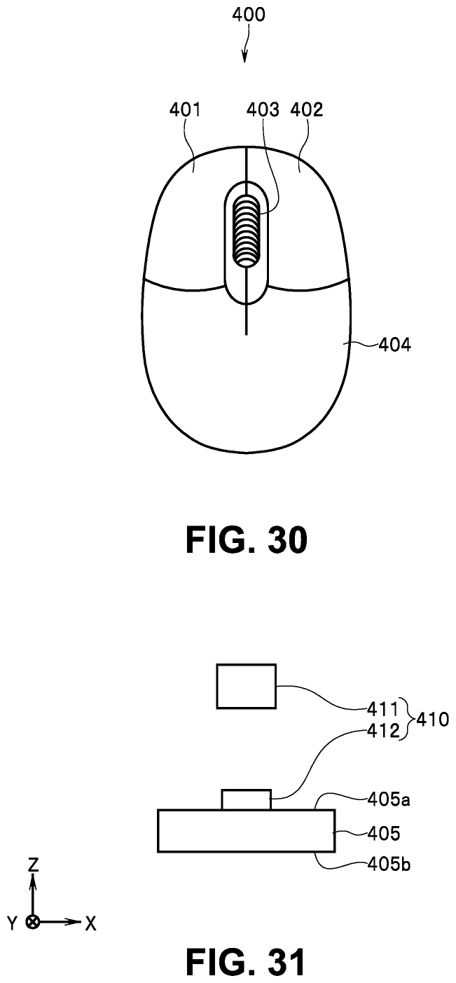

A fifth example embodiment of the technology will now be described with reference to FIGS. 30 and 31. FIG. 30 is a plan view showing a mouse in the example embodiment. FIG. 31 is a side view showing a position detection device according to the example embodiment.

A mouse 400 in the example embodiment is used, for example, as a mouse for a personal computer in which a user performs operations including clicking and dragging and dropping. The mouse 400 includes a left button 401 and a right button 402 each configured to allow at least one of clicking or depressing, a wheel 403, a case 404, and a substrate 405 provided within the case 404. The substrate 405 has a top surface 405a and a bottom surface 405b on an opposite side of the top surface 405a.

The mouse 400 further includes a plurality of position detection devices 410 according to the example embodiment. The plurality of position detection devices 410 each include a position detection device configured to detect at least one of clicking or depressing of the left button 401 and a position detection device configured to detect at least one of clicking or depressing of the right button 402.

The wheel 403 is configured to be rotatable. The wheel 403 may further be configured so that clicking and depressing are possible. In this case, the plurality of position detection devices 410 may further include a position detection device configured to detect the clicking and depressing of the wheel 403.

Next, a configuration of the position detection device 410 will be described. The configuration of the position detection device 410 is basically similar to the configuration of the position detection device 330 according to the third example embodiment. In other words, the position detection device 410 includes a magnetic field generator 411 and a magnetic sensor 412. The magnetic field generator 411 is configured to move in a direction parallel to the Z direction in conjunction with the left button 401, the right button 402, or the wheel 403. The magnetic field generator 411 generates a target magnetic field, which is a magnetic field for the magnetic sensor 412 to detect (magnetic field to be detected). The magnetic field generator 411 may be, for example, a magnet magnetized in a direction parallel to the X direction.

The magnetic sensor 412 detects the target magnetic field at a detection position in the reference plane and generates a detection signal corresponding to variation in the target magnetic field. The magnetic sensor 412 is fixed to the top surface 405a of the substrate 405. Note that the magnetic sensor 412 may be fixed to the bottom surface 405b of the substrate 405. The magnetic sensor 412 may be arranged to overlap the magnetic field generator 411 when seen in the Z direction.

The description of the key cap 310, the magnetic field generator 331, and the magnetic sensor 332 in the third example embodiment basically also applies to the left button 401 (the right button 402 or the wheel 403), the magnetic field generator 411, and the magnetic sensor 412.

Other configurations, operation, and effects in the example embodiment are the same as in the third example embodiment.

### Sixth Example Embodiment

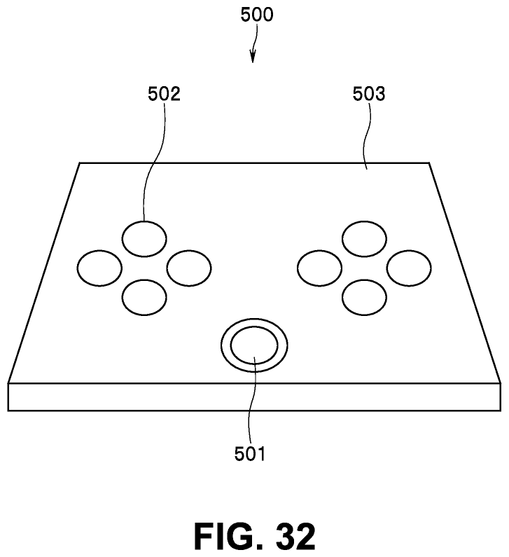

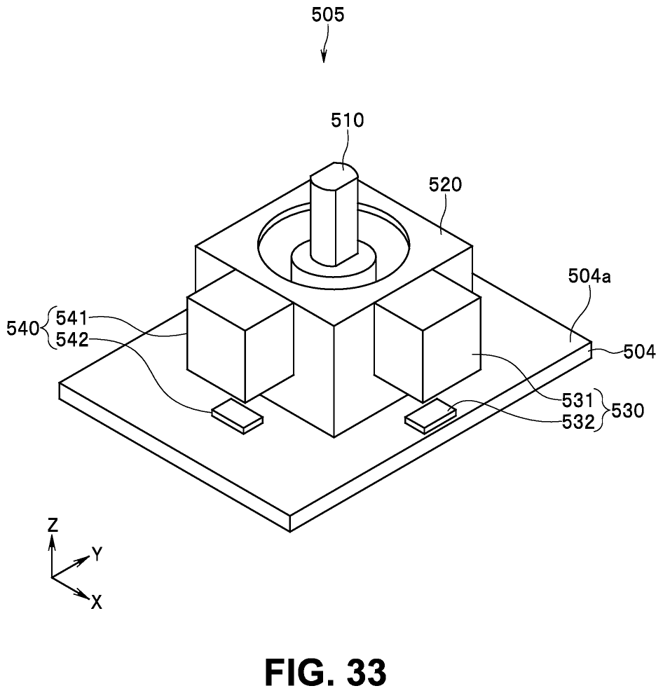

A sixth example embodiment of the technology will now be described with reference to FIGS. 32 and 33. FIG. 32 is an explanatory diagram showing a game controller in the example embodiment. FIG. 33 is a perspective view showing a stick device in the example embodiment.

A game controller 500 in the example embodiment is also referred to as a gamepad or a joystick, and is used, for example, as a game controller for a home gaming console or a personal computer. The game controller 500 includes a stick button 501 configured to allow at least one of a directional operation or depressing, a plurality of buttons 502 each configured to be depressed, a case 503, and a substrate 504 provided in the case 503. The substrate 504 has a top surface 504a and a bottom surface on an opposite side of the top surface 504a.

The stick button 501 includes a stick device 505 provided in the case 503. The stick device 505 includes a lever 510 and a housing 520 which accommodates a base of the lever 510 and is fixed to the substrate 504. A stick is fixed to a distal end portion of the lever 510. The lever 510 and the housing 520 are configured to hold the lever 510 at a predetermined position.

The lever 510 is configured to be inclinable in any direction that intersects the Z direction. The lever 510 is further configured to be depressable in the −Z direction, and configured to be subjected to a biasing force in a direction opposite to the depressing force, i.e., in the Z direction. The lever 510 and the housing 520 are configured to return the lever 510 to the above-mentioned predetermined position when an external force is no longer applied to the lever 510.

The game controller 500 further includes position detection devices 530 and 540 according to the example embodiment. The position detection devices 530 and 540 are each configured to detect the depressing of the lever 510.

Next, configurations of the position detection devices 530 and 540 will be described. The configurations of the position detection devices 530 and 540 are basically the same as the configuration of the position detection device 330 according to the third example embodiment. In other words, the position detection device 530 includes a magnetic field generator 531 and a magnetic sensor 532. The position detection device 540 includes a magnetic field generator 541 and a magnetic sensor 542. The magnetic field generators 531 and 541 are configured to move in a direction parallel to the Z direction in conjunction with the lever 510. The magnetic field generator 531 generates a target magnetic field, which is a magnetic field for the magnetic sensor 532 to detect (magnetic field to be detected). The magnetic field generator 541 generates a target magnetic field, which is a magnetic field for the magnetic sensor 542 to detect (magnetic field to be detected). Each of the magnetic field generators 531 and 541 may be, for example, a magnet magnetized in a direction parallel to the X direction.

Each of the magnetic sensors 532 and 542 detects the target magnetic field at a detection position in the reference plane and generates a detection signal corresponding to variation in the target magnetic field. Each of the magnetic sensors 532 and 542 is fixed to the top surface 504a of the substrate 504. Note that at least one of the magnetic sensors 532 and 542 may be fixed to the bottom surface of the substrate 504. The magnetic sensor 532 may be arranged to overlap the magnetic field generator 531 when seen in the Z direction. The magnetic sensor 542 may be arranged to overlap the magnetic field generator 541 when seen in the Z direction.

The description of the key cap 310, the magnetic field generator 331, and the magnetic sensor 332 in the third example embodiment basically also applies to the lever 510, the magnetic field generators 531 and 541, and the magnetic sensors 532 and 542.

Note that one of the position detection devices 530 and 540 may not be provided. Other configurations, operation, and effects in the example embodiment are the same as in the third example embodiment.

### Seventh Example Embodiment

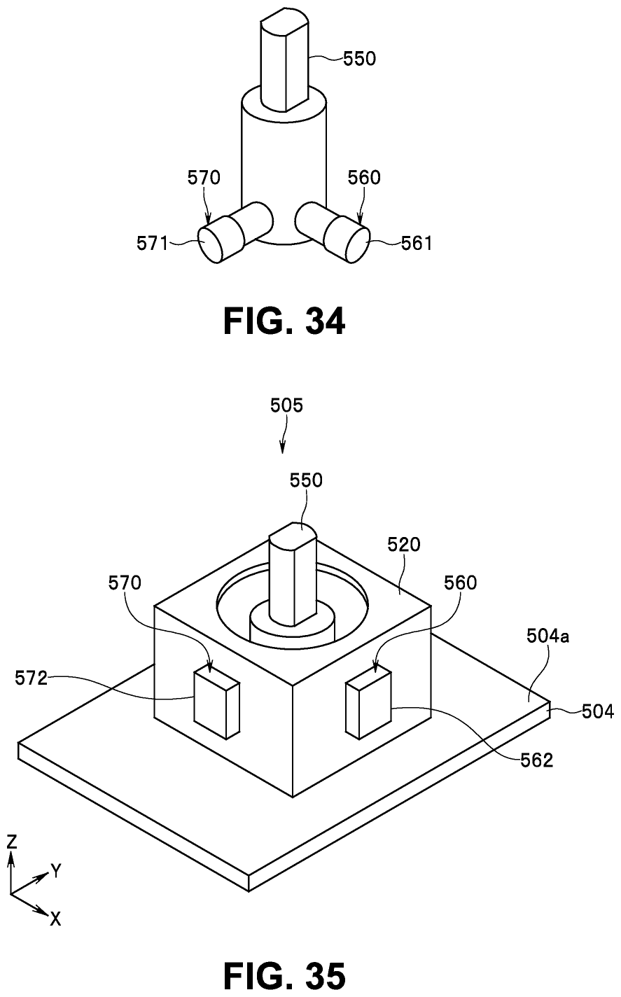

A seventh example embodiment of the technology will now be described with reference to FIGS. 34 and 35. FIG. 34 is a perspective view showing a lever in the example embodiment. FIG. 35 is a perspective view showing a stick device in the example embodiment.

A game controller 500 in the example embodiment differs from the sixth example embodiment in the following respects. In the example embodiment, a stick device 505 includes a lever 550 instead of the lever 510 in the sixth example embodiment. Magnetic field generators 561 and 571 are fixed to a base of the lever 550. The other configurations of the lever 550 are similar to those of the lever 510 in the sixth example embodiment.

In the example embodiment, the game controller 500 includes position detection devices 560 and 570 according to the example embodiment instead of the position detection devices 530 and 540 according to the sixth example embodiment. The position detection devices 560 and 570 are each configured to detect inclination of the lever 550.

Next, configurations of the position detection devices 560 and 570 will be described. The position detection device 560 includes a magnetic field generator 561 and a magnetic sensor 562. The position detection device 570 includes a magnetic field generator 571 and a magnetic sensor 572. The magnetic field generators 561 and 571 are configured to move in a direction that intersects the Z direction in conjunction with the lever 550. The magnetic field generator 561 generates a target magnetic field, which is a magnetic field for the magnetic sensor 562 to detect (magnetic field to be detected). The magnetic field generator 571 generates a target magnetic field, which is a magnetic field for the magnetic sensor 572 to detect (magnetic field to be detected). Each of the magnetic field generators 561 and 571 may be, for example, a magnet magnetized in a predetermined direction.

Each of the magnetic sensors 562 and 572 detects the target magnetic field at a detection position in the reference plane and generates a detection signal corresponding to variation in the target magnetic field. Each of the magnetic sensors 562 and 572 is fixed to the housing 520 of the stick device 505.

The description of the key cap 310, the magnetic field generator 331, and the magnetic sensor 332 in the third example embodiment basically also applies to the lever 510, the magnetic field generators 561 and 571, and the magnetic sensors 562, 572.

Note that one of the position detection devices 560 and 570 may not be provided. The other configurations, operation, and effects in the example embodiment are the same as in the sixth example embodiment.

The technology is not limited to the foregoing example embodiments, and various modifications may be made thereto. The configurations of the magnetic field generators 10 and 210 and the magnetic sensors 20 and 220 are not limited to the examples described in the example embodiments, and any configuration may be employed as long as the requirements set forth in the claims are satisfied. For example, the magnetic sensors 20 and 220 may be configured to include the power supply port V, the ground port G, the first output port E1, the first resistor section R1, the second resistor section R2, and the first resistor Ro1, and include none of the second output port E2, the third resistor section R3, the fourth resistor section R4, and the second resistor Ro2. In such a case, the detection signal is a signal depending on the electric potential at the first output port E1.

The first resistor Ro1 may be connected in series to the at least one second MR element so that the first resistor Ro1 is located between the first output port E1 and the ground port G. In such a case, the second resistor Ro2 is connected in series to the at least one third MR element so that the second resistor Ro2 is located between the power supply port V and the second output port E2.

The position detection device is not limited to the configuration in which the position of the magnetic sensor is fixed and the position of the magnetic field generator varies, but may have a configuration in which the position of the magnet field generator is fixed and the position of the magnetic sensor varies.

As described above, the position detection device according to one example embodiment of the technology is the position detection device for detecting the position of an object whose position is variable. The position detection device according to one example embodiment of the technology includes the magnetic field generator configured to generate a target magnetic field and vary the target magnetic field when the position of the object varies, and the magnetic sensor that detects the target magnetic field and generates the detection signal corresponding to the variation in the target magnetic field. The magnetic field generator is configured so that the mode of the variation in the target magnetic field relative to the variation in the position of the object is such that the target magnetic field varies nonlinearly relative to the variation in the position of the object. The magnetic sensor is configured so that the mode of the variation in the detection signal relative to the variation in the target magnetic field is such that the detection signal varies nonlinearly relative to the variation in the target magnetic field.

In the position detection device according to one example embodiment of the technology, the target angle that the direction of the target magnetic field forms with the reference direction in the reference plane may vary within the first variable range corresponding to the movable range of the position of the object. In this case, the detection signal may vary within the second variable range corresponding to the first variable range. In this case, the magnetic sensor may include at least one magnetoresistive element. Each of the at least one magnetoresistive element may be configured to include the magnetization pinned layer having the first magnetization whose direction is fixed, and the free layer having the second magnetization whose direction is variable according to the direction of the target magnetic field, and may be configured so that the angle that the second magnetization direction forms with the first magnetization direction when the object is located at the center of the movable range falls within the range of 0° or more and 70° or less, within the range of 110° or more and 250° or less, or within the range of 290° or more and less than 360°.

In the position detection device according to one example embodiment of the technology, when the magnetic sensor includes at least one magnetoresistive element, each of the at least one magnetoresistive element may be configured so that the angle that the second magnetization direction forms with the first magnetization direction when the object is located at the center of the movable range falls within the range of 10° or more and 60° or less, within the range of 120° or more and 170° or less, within the range of 190° or more and 240° or less, or within the range of 300° or more and 350° or less.

In the position detection device according to one example embodiment of the technology, when the magnetic sensor includes at least one magnetoresistive element, the at least one magnetoresistive element may include at least one first magnetoresistive element and at least one second magnetoresistive element. The magnetic sensor may further include the power supply port to which the predetermined voltage is applied, the ground port connected to the ground, and the output port. In this case, the at least one first magnetoresistive element is provided between the power supply port and the output port. The at least one second magnetoresistive element is provided between the output port and the ground port.

The first magnetization direction of the magnetization pinned layer in each of the at least one first magnetoresistive element is the first direction. The first magnetization direction of the magnetization pinned layer in each of the at least one second magnetoresistive element is the second direction opposite to the first direction. The detection signal depends on the electric potential at the output port.

In the position detection device according to one example embodiment of the technology, when the magnetic sensor includes at least one magnetoresistive element, the at least one magnetoresistive element may include at least one first magnetoresistive element, at least one second magnetoresistive element, at least one third magnetoresistive element, and at least one fourth magnetoresistive element. The magnetic sensor may further include the power supply port to which the predetermined voltage is applied, the ground port connected to the ground, the first output port, and the second output port. In this case, the at least one first magnetoresistive element is provided between the power supply port and the first output port. The at least one second magnetoresistive element is provided between the first output port and the ground port. The at least one third magnetoresistive element is provided between the power supply port and the second output port. The at least one fourth magnetoresistive element is provided between the second output port and the ground port.

The first magnetization direction of the magnetization pinned layer in each of the at least one first magnetoresistive element and the first magnetization direction of the magnetization pinned layer in each of the at least one fourth magnetoresistive element are the first direction. The first magnetization direction of the magnetization pinned layer in each of the at least one second magnetoresistive element and the first magnetization direction of the magnetization pinned layer in each of the at least one third magnetoresistive element are the second direction opposite to the first direction. The detection signal depends on the potential difference between the first output port and the second output port.

In the position detection device according to one example embodiment of the technology, the object may vary in position in the linear direction. In this case, the magnetic sensor according to one example embodiment of the technology may further include the substrate having the top surface and on which the magnetic sensor is fixed. The position of the object may vary in the direction perpendicular to the top surface of the substrate. The magnetic field generator may include the first magnetic field generation unit that generates the first magnetic field and the second magnetic field generation unit that generates the second magnetic field. The position of the second magnetic field generation unit relative to the first magnetic field generation unit may vary as the position of the object varies. When the component of the first magnetic field parallel to the reference plane at the detection position is the first magnetic field component and the component of the second magnetic field parallel to the reference plane at the detection position is the second magnetic field component, the first magnetic field generation unit and the second magnetic field generation unit may be configured such that, when the position of the second magnetic field generation unit relative to the first magnetic field generation unit varies, the strength and direction of the first magnetic field component and the direction of the second magnetic field component do not vary, but the strength of the second magnetic field component varies. The target magnetic field may be the composite magnetic field of the first magnetic field component and the second magnetic field component.

When the magnetic field generator includes the first and second magnetic field generation units, the first magnetic field generation unit may have two magnets arranged in different positions from each other. The first magnetic field may be a composite of the two magnetic fields generated by the two magnets, respectively. In this case, the position detection device according to one example embodiment of the technology may further include the first holding member that holds the first magnetic field generation unit, and the second holding member that is provided such that its position is variable in one direction relative to the first holding member and that holds the second magnetic field generating unit.

When the position detection device according to one example embodiment of the technology includes the first and second holding members, the object may be the lens. The second holding member may hold the lens and may be provided such that its position is variable relative to the first holding member in the direction of the optical axis of the lens.

In the position detection device according to one example embodiment of the technology, the object may be a rotating body whose position varies in the direction of rotation about the center axis. In this case, the magnetic field generator may be connected to the rotating body.

The key switch according to one example embodiment of the technology includes the key cap, the holding member configured to hold the key cap while allowing the key cap to move linearly, and the position detection device for detecting the position of the key cap. The position detection device includes the magnetic field generator configured to generate the target magnetic field and vary the target magnetic field when the position of the key cap varies, and the magnetic sensor that detects the target magnetic field and generates the detection signal corresponding to the variation in the target magnetic field. The magnetic field generator is configured so that the mode of the variation in the target magnetic field relative to the variation in the position of the key cap is such that the target magnetic field varies nonlinearly relative to the variation in the position of the key cap. The magnetic sensor is configured so that the mode of the variation in the detection signal relative to the variation in the target magnetic field is such that the detection signal varies nonlinearly relative to the variation in the target magnetic field.

In the key switch according to one example embodiment of the technology, the holding member may include the stem to which the key cap is fixed. The magnetic field generator may be fixed to the stem.

The keyboard according to one example embodiment of the technology includes the plurality of key switches, the switch plate to which the plurality of key switches are fixed, and the substrate. Each of the plurality of key switches includes the key cap, the holding member configured to hold the key cap while allowing the key cap to move linearly, and the position detection device for detecting the position of the key cap. The position detection device includes the magnetic field generator configured to generate the target magnetic field and vary the target magnetic field when the position of the key cap varies, and the magnetic sensor that detects the target magnetic field and generates the detection signal corresponding to the variation in the target magnetic field. The magnetic field generator is configured so that the mode of the variation in the target magnetic field relative to the variation in the position of the key cap is such that the target magnetic field varies nonlinearly relative to the variation in the position of the key cap. The magnetic sensor is configured so that the mode of the variation in the detection signal relative to the variation in the target magnetic field is such that the detection signal varies nonlinearly relative to the variation in the target magnetic field.

In the keyboard according to one example embodiment of the technology, the holding member may include the stem to which the key cap is fixed. The magnetic field generator may be fixed to the stem.

In the keyboard according to one example embodiment of the technology, the magnetic sensor may be fixed to the substrate.

The mouse according to one example embodiment of the technology includes the button configured to allow at least one of clicking or depressing, the position detection device configured to detect at least one of the clicking or depressing of the button, and the case. The position detection device includes the magnetic field generator configured to generate the target magnetic field and vary the target magnetic field when the position of the button varies, and the magnetic sensor that detects the target magnetic field and generates the detection signal corresponding to the variation in the target magnetic field. The magnetic field generator is configured so that the mode of the variation in the target magnetic field relative to the variation in the button is such that the target magnetic field varies nonlinearly relative to the variation in the position of the button. The magnetic sensor is configured so that the mode of the variation in the detection signal relative to the variation in the target magnetic field is such that the detection signal varies nonlinearly relative to the variation in the target magnetic field.

The game controller according to one example embodiment of the technology includes the stick button configured to allow at least one of the directional operation or the depressing, the position detection device, the case, and the substrate provided in the case. The stick button includes the stick device provided in the case. The stick device includes the lever and the housing that accommodates the base of the lever and is fixed to the substrate. The position detection device includes the magnetic field generator configured to generate the target magnetic field and vary the target magnetic field when the position of the lever varies, and the magnetic sensor that detects the target magnetic field and generates the detection signal corresponding to the variation in the target magnetic field. The magnetic field generator is configured so that the mode of the variation in the target magnetic field relative to the variation in the position of the lever is such that the target magnetic field varies nonlinearly relative to the variation in the position of the lever. The magnetic sensor is configured so that the mode of the variation in the detection signal relative to the variation in the target magnetic field is such that the detection signal varies nonlinearly relative to the variation in the target magnetic field.

The camera module according to one example embodiment of the technology includes the lens whose position is variable in the linear direction, the position detection device for detecting the position of the lens, the holding member for holding the lens, and the driving device for moving the holding member. The position detection device includes the magnetic field generator configured to generate the target magnetic field and vary the direction of the target magnetic field at the detection position in the reference plane when the position of the lens varies, and the magnetic sensor that detects the target magnetic field and generates the detection signal corresponding to the direction of the target magnetic field. The magnetic field generator is configured so that the mode of the variation in the direction of the target magnetic field relative to the variation in the position of the lens is such that the direction of the target magnetic field varies nonlinearly relative to the variation in the position of the lens. The magnetic sensor is configured so that the mode of the variation in the detection signal relative to the variation in the direction of the target magnetic field is such that the detection signal varies nonlinear relative to the variation in the direction of the target magnetic field.

The rotary actuator according to one example embodiment of the technology includes the rotating body whose position is variable in the direction of rotation about the center axis, the position detection device for detecting the position of the rotating body, and the driving device for rotating the rotating body. The position detection device includes the magnetic field generator configured to generate the target magnetic field and vary the direction of the target magnetic field at the detection position in the reference plane when the position of the rotating body varies, and the magnetic sensor that detects the target magnetic field and generates the detection signal corresponding to the direction of the target magnetic field. The magnetic field generator is configured so that the mode of the variation in the direction of the target magnetic field relative to the variation in the position of the rotating body is such that the direction of the target magnetic field varies nonlinearly relative to the variation in the position of the rotating body. The magnetic sensor is configured so that the mode of the variation in the detection signal relative to the variation in the direction of the target magnetic field is such that the detection signal varies nonlinearly relative to the variation in the direction of the target magnetic field.

In the position detection device, the key switch, the keyboard, the mouse, and the game controller according to one example embodiment of the technology, the magnetic field generator is configured so that the mode of the variation in the target magnetic field relative to the variation in the position of the object is such that the target magnetic field varies nonlinearly relative to the variation in the position of the object, and the magnetic sensor is configured so that the mode of the variation in the detection signal relative to the variation in the target magnetic field is such that the detection signal varies nonlinearly relative to the variation in the target magnetic field. Accordingly, this makes it possible to vary the detection signal linearly relative to the variation in the position of the object, even if the target magnetic field varies nonlinearly relative to the variation in the position of the object.

Obviously, many modifications and variation in the technology are possible in the light of the above teachings. Thus, it is to be understood that, within the scope of the appended claims and equivalents thereof, the technology may be practiced in other embodiments than the foregoing most preferable embodiments.

1. A position detection device for detecting a position of an object whose position is variable, the position detection device comprising:
a magnetic field generator configured to generate a target magnetic field and vary the target magnetic field when the position of the object varies; and
a magnetic sensor that detects the target magnetic field and generates a detection signal corresponding to variation in the target magnetic field, wherein
the magnetic field generator is configured so that a mode of the variation in the target magnetic field relative to variation in the position of the object varies nonlinearly relative to the variation in the position of the object, and
the magnetic sensor is configured so that a mode of variation in the detection signal relative to the variation in the target magnetic field varies nonlinearly relative to the variation in the target magnetic field.

2. The position detection device according to claim 1, wherein:
a target angle that a direction of the target magnetic field forms with a reference direction in a reference plane varies within a first variable range corresponding to a movable range of the position of the object; and
the detection signal varies within a second variable range corresponding to the first variable range.

3. The position detection device according to claim 2, wherein:
the magnetic sensor includes at least one magnetoresistive element; and
the at least one magnetoresistive element each includes a magnetization pinned layer having a first magnetization whose direction is fixed, and a free layer having a second magnetization whose direction is variable according to the direction of the target magnetic field, the at least one magnetoresistive element each being configured so that an angle that a direction of the second magnetization with a direction of the first magnetization when the object is located at a center of the movable range falls within a range of 0° or more and 70° or less, within a range of 110° or more and 250° or less, or within a range of 290° or more and less than 360°.

4. The position detection device according to claim 3, wherein the at least one magnetoresistive element is each configured so that the angle that the direction of the second magnetization forms with the direction of the first magnetization when the object is located at the center of the movable range falls within a range of 10° or more and 60° or less, within a range of 120° or more and 170° or less, within a range of 190° or more and 240° or less, or within a range of 300° or more and 350° or less.

5. The position detection device according to claim 3, wherein:
the at least one magnetoresistive element includes at least one first magnetoresistive element and at least one second magnetoresistive element;
the magnetic sensor further includes a power supply port to which a predetermined voltage is applied, a ground port that is connected to a ground, and an output port;
the at least one first magnetoresistive element is provided between the power supply port and the output port;
the at least one second magnetoresistive element is provided between the output port and the ground port;
the direction of the first magnetization of the magnetization pinned layer in each of the at least one first magnetoresistive element is a first direction;
the direction of the first magnetization of the magnetization pinned layer in each of the at least one second magnetoresistive element is a second direction opposite to the first direction; and
the detection signal depends on an electric potential at the output port.

6. The position detection device according to claim 3, wherein:
the at least one magnetoresistive element includes at least one first magnetoresistive element, at least one second magnetoresistive element, at least one third magnetoresistive element, and at least one fourth magnetoresistive element;
the magnetic sensor further includes a power supply port to which a predetermined voltage is applied, a ground port that is connected to a ground, a first output port, and a second output port;
the at least one first magnetoresistive element is provided between the power supply port and the first output port;
the at least one second magnetoresistive element is provided between the first output port and the ground port;
the at least one third magnetoresistive element is provided between the power supply port and the second output port;
the at least one fourth magnetoresistive element is provided between the second output port and the ground port;
the direction of the first magnetization of the magnetization pinned layer in each of the at least one first magnetoresistive element and the direction of the first magnetization of the magnetization pinned layer in each of the at least one fourth magnetoresistive element are a first direction;
the direction of the first magnetization of the magnetization pinned layer in each of the at least one second magnetoresistive element and the direction of the first magnetization of the magnetization pinned layer in each of the at least one third magnetoresistive element are a second direction opposite to the first direction; and
the detection signal depends on a potential difference between the first output port and the second output port.

7. The position detection device according to claim 1, wherein the position of the object varies in a linear direction.

8. The position detection device according to claim 7, further comprising:
a substrate that has a top surface and to which the magnetic sensor is fixed, wherein
the position of the object varies in a direction perpendicular to the top surface of the substrate.

9. A key switch comprising:
a key cap;
a holding member configured to hold the key cap while allowing the key cap to move linearly; and
a position detection device for detecting a position of the key cap, wherein
the position detection device includes:
a magnetic field generator configured to generate a target magnetic field and vary the target magnetic field when the position of the key cap varies; and
a magnetic sensor that detects the target magnetic field and generates a detection signal corresponding to variation in the target magnetic field,
the magnetic field generator is configured so that a mode of the variation in the target magnetic field relative to variation in the position of the key cap varies nonlinearly relative to the variation in the position of the key cap, and
the magnetic sensor is configured so that a mode of variation in the detection signal relative to the variation in the target magnetic field varies nonlinearly relative to the variation in the target magnetic field.

10. The key switch according to claim 9, wherein
the holding member includes a stem to which the key cap is fixed, and
the magnetic field generator is fixed to the stem.

11. A keyboard comprising:
a plurality of key switches;
a switch plate to which the plurality of key switches are fixed; and
a substrate, wherein
each of the plurality of key switches includes:
a key cap;
a holding member configured to hold the key cap while allowing the key cap to move linearly; and
a position detection device for detecting a position of the key cap,
the position detection device includes:
a magnetic field generator configured to generate a target magnetic field and vary the target magnetic field when the position of the key cap varies; and
a magnetic sensor that detects the target magnetic field and generates a detection signal corresponding to variation in the target magnetic field,
the magnetic field generator is configured so that a mode of the variation in the target magnetic field relative to variation in the position of the key cap varies nonlinearly relative to the variation in the position of the key cap, and
the magnetic sensor is configured so that a mode of variation in the detection signal relative to the variation in the target magnetic field varies nonlinearly relative to the variation in the target magnetic field.

12. The keyboard according to claim 11, wherein
the holding member includes a stem to which the key cap is fixed, and
the magnetic field generator is fixed to the stem.

13. The keyboard according to claim 11, wherein the magnetic sensor is fixed to the substrate.

14. A mouse comprising:
a button configured to allow at least one of clicking or depressing;
a position detection device configured to detect at least one of the clicking or the depressing of the button; and
a case, wherein
the position detection device includes:
a magnetic field generator configured to generate a target magnetic field and vary the target magnetic field when a position of the button varies; and
a magnetic sensor that detects the target magnetic field and generates a detection signal corresponding to variation in the target magnetic field,
the magnetic field generator is configured so that a mode of the variation in the target magnetic field relative to variation in the position of the button varies nonlinearly relative to the variation in the position of the button, and
the magnetic sensor is configured so that a mode of variation in the detection signal relative to the variation in the target magnetic field varies nonlinearly relative to the variation in the target magnetic field.

15. A game controller comprising:
a stick button configured to allow at least one of a directional operation or depressing;
a position detection device;
a case; and
a substrate provided in the case, wherein
the stick button includes a stick device provided in the case,
the stick device includes a lever, and a housing that accommodates a base of the lever and is fixed to the substrate,
the position detection device includes:
a magnetic field generator configured to generate a target magnetic field and vary the target magnetic field when a position of the lever varies, and
a magnetic sensor that detects the target magnetic field and generates a detection signal corresponding to variation in the target magnetic field,
the magnetic field generator is configured so that a mode of the variation in the target magnetic field relative to variation in the position of the lever varies nonlinearly relative to the variation in the position of the lever, and
the magnetic sensor is configured so that a mode of variation in the detection signal relative to the variation in the target magnetic field varies nonlinearly relative to the variation in the target magnetic field.
